(19) United States
(12) Patent Application Publication
(10) Pub. No.: US 2004/0042648 A1
(43) Pub. Date: Mar. 4, 2004

(54) Image processing method and unit, detecting method and unit, and exposure method and apparatus

(75) Inventors: Kouji Yoshidda, Yokohama-shi (JP); Makiko Yoshida, Yokohama-shi (JP); Masafumi Mimura, Kumagaya-shi (JP); Tarou Sugihara, Setagaya-ku (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: Nikon Corporation, Tokyo (JP)

(21) Appl. No.: 10/447,230

(22) Filed: May 29, 2003

Related U.S. Application Data
(63) Continuation of application No. PCT/JP01/10394, filed on Nov. 28, 2001.

(30) Foreign Application Priority Data
Nov. 29, 2000 (JP) 2000-362,758
Nov. 29, 2000 (JP) 2000-362,659
May 15, 2001 (JP) 2001-144,984
Jun. 6, 2001 (JP) 2001-170,365

(51) Int. Cl. G06K 9/00

(52) U.S. Cl. 382/151

(57) ABSTRACT

An image of a plurality of areas of which two adjacent areas have different image characteristics from each other are acquired (steps 111 through 114); the image is analyzed in light of the difference between image characteristics, for example textures, of the two adjacent areas (step 115), and information about the boundary between the two adjacent areas is obtained (step 116). And by detecting shape information and/or position information of a given image area based on the obtained boundary information, shape information, position information, optical characteristic information, etc., of the object are detected (step 117). Thus, shape information, position information, optical characteristic information, etc., of the object are accurately detected.

### CROSS-REFERENCE TO RELATED APPLICATIONS

This is a continuation of International Application PCT/JP01/10394, with an international filing date of Nov. 28, 2001, the entire content of which being hereby incorporated herein by reference, which was not published in English.

### BACKGROUND OF THE INVENTION

1. Field of the Invention

The present invention relates to an image processing method and unit, a detecting method and unit, and an exposure method and apparatus and more specifically to an image processing method and unit for processing image data obtained by pickup, etc., a detecting method and unit that uses the image processing method, and an exposure method and apparatus that uses the detecting method.

2. Description of the Related Art

To date, in a lithography process for manufacturing semiconductor devices, liquid crystal display devices, or the like, exposure apparatuses have been used which transfer a pattern formed on a mask or reticle (generically referred to as a “reticle” hereinafter) onto a substrate such as a wafer or glass plate (hereinafter, generically referred to as a “substrate” or “wafer” as needed) coated with a resist, through a projection optical system. As such an exposure apparatus, a stationary exposure type projection exposure apparatus such as the so-called stepper, or a scanning exposure type projection exposure apparatus such as the so-called scanning stepper is mainly used.

In such an exposure apparatus when detecting position to very accurately align a reticle with a wafer before exposure and detecting coherence factor a (hereinafter, called “illumination σ”) of the projection optical system, an image of the wafer's periphery and a light source image on a plane conjugate to the entrance pupil of the projection optical system, formed by illumination light (exposure light) incident on the projection optical system are picked up. And the images, the picking-up results, are analyzed to extract the outer shape of the wafer to detect the wafer's position and to extract the outer shape of the light source image to measure illumination σ that influences the imaging characteristic of the projection optical system.

Moreover, various techniques for very accurately detecting a wafer's position have been suggested, and of the prior art position detecting techniques, enhanced global alignment (hereinafter, called “EGA”) is widely being used. In EGA in order to very accurately detect the positional relation between a reference coordinate system for specifying movement of the wafer and an arrangement coordinate system (wafer coordinate system) for arrangement of shot areas on the wafer, fine alignment marks on the wafer are measured which have been transferred together with a circuit pattern, and after computing arrangement coordinates of each shot area by use of the least-squares method, etc., stepping is, upon exposure, performed according to the accuracy of the wafer stage by use of the computing result.

Because, in EGA, fine alignment marks formed in predetermined positions on the wafer need to be viewed with high magnification, the view field is necessarily narrow. Therefore, in order to surely catch the fine alignment marks with the narrow view field, by detecting the center position and rotation about its normal, center axis of the wafer based on the result of viewing the wafer's periphery before fine alignment, the positional relation between the reference coordinate system and the arrangement coordinate system is detected with a predetermined accuracy, which detection is called “pre-alignment” hereinafter.

In such pre-alignment, the images of three or more parts of the wafer's periphery are picked up while illuminating the wafer with, for example, a transmission illumination method. As a result, a wafer image and a background image around the wafer's outer edge in the pickup field are obtained which each have substantially uniform brightness and are different from each other in brightness. Therefore, an appropriate threshold for brightness is set based on how brightness varies in the whole image as the picking-up result, and it is judged based on the relation in value between the threshold and the brightness of each pixel whether the pixel is in the wafer image area or the background image area, to detect position information of the wafer's outer edge. And based on position information of three or more parts of the wafer's outer edge, the center position and rotation about its normal, center axis of the wafer are detected.

After the pre-alignment, while the wafer and a search alignment detection system are relatively moved in light of, e.g., the positional relation between the reference coordinate system and the arrangement coordinate system obtained in the pre-alignment, a plurality of search alignment marks on the wafer are captured with a relatively broad view field to detect the positions of the search alignment marks. Based on the detecting results, the positional relation between the reference coordinate system and the arrangement coordinate system is detected with accuracy necessary to view the fine alignment marks. While the wafer and a fine alignment detection system are relatively moved in light of the accurately obtained positional relation between the reference coordinate system and the arrangement coordinate system, the plurality of fine alignment marks on the wafer are viewed, so that fine alignment is completed.

Further, in the pre-alignment the images of at least three parts of the wafer's periphery are generally picked up as described above, which images are processed to detect the position of the wafer's outer edge. For the purpose of accurately detecting position in the pre-alignment, the characteristic of a pickup unit such as a CCD camera used in picking up needs to be accurately corrected. That is, it is necessary to accurately correct the magnifications (in X and Y directions) of the pickup unit, rotation of its pickup field and the like before exposure of the wafer.

In such correction of the characteristic of a pickup unit, a correction measurement wafer on the periphery of which three cross marks each having two rectangular patterns arranged diagonally therein are formed in respective three positions is used in the prior art. Correction is performed using the correction measurement wafer in the following manner.

First, while moving a wafer stage on which the correction measurement wafer has been mounted, a pickup unit that is to be corrected picks up the images of the cross marks on the correction measurement wafer, and using a template pattern where two rectangular areas are arranged diagonally which have brightness of a first value and correspond to the respective two rectangular patterns of the cross mark, and where the other areas have brightness of a second value different from the first value, template matching is performed on the picking-up result to detect information about position in the pickup field of the cross mark. And based on the relation between the movement of the wafer stage and corresponding variation of the position information of the cross mark, the magnification of the pickup unit, rotation of its pickup field, and the like are corrected.

In the case of detecting the wafer's position and measuring illumination a by processing the wafer image and the light source image picked up, even if the wafer image area and a light source image area have a first intrinsic pattern (or uniform brightness), and background image areas have a second intrinsic pattern (or uniform brightness), it is sometimes difficult to estimate the outer edges of the wafer image and the light source image directly from variation of brightness in the picking-up result. For example, when brightness of either of bright portions and dark portions in the intrinsic pattern of the wafer image area or the light source image area is almost the same as brightness of the background image area, which is uniform, portions having almost the same brightness are present on the both sides of, and around, the outer edge of the wafer image or the light source image. As a result, it is difficult to estimate the outer edge of the wafer image or the light source image as a continuous line directly from variation of brightness in the picking-up result.

Therefore, the wafer's position and illumination a cannot be accurately detected sometimes when an area subject to the outer edge estimation such as the wafer image area and the light source image area and a background area have a respective intrinsic pattern.

Further, when raw image data obtained by pickup is used and noise is included in the image data of the periphery of the wafer image or the light source image, the wafer's position and illumination a cannot be accurately detected.

In the above prior art pre-alignment using a threshold, position information of a wafer's outer edge is detected based on the relation in value between the threshold and the brightness of each pixel, for example, that the brightness of each pixel is greater than the threshold or is equal to or less than the threshold (or that the brightness of each pixel is equal to or greater than the threshold or is less than the threshold). That is, a multi step image as a picking-up result, which is of three or more steps, is converted to a binary image by use of the threshold, and from the binary image, position information of a wafer's outer edge is detected with accuracy of the dimension of pixels.

The prior art position detecting method is simple and excellent in terms of high speed processing. However, pre-alignment based on position information of the wafer's outer edge detected by the prior art position detecting method hardly satisfies the demand in recent years for increasingly improved accuracy of pre-alignment.

Further, in the above-mentioned method of correcting a pickup unit for pre-alignment, in order to detect position information of a cross mark in the pickup field, the correlation between a template pattern having rectangular areas therein and the image datum of each pixel in the pickup field is calculated, so that the amount of calculating the correlation is extremely large. Therefore, there is a limit on quickly correcting the pickup unit with maintaining the accuracy in correction.

Further, because there is a possibility that the correction measurement wafer is rotated with respect to the field coordinate system of the pickup unit, template matching with a single template pattern does not necessarily ensure accuracy in detecting position information of the cross mark.

### SUMMARY OF THE INVENTION

This invention was made under such circumstances, and a first purpose of the present invention is to provide an image processing method and unit that can accurately estimate the boundary of areas.

Still further, a second purpose of the present invention is to provide a detecting method and unit that can accurately detect position information of an object as characteristic information of the object.

Yet further, a third purpose of the present invention is to provide an exposure method and apparatus that can perform very accurate exposure.

According to a first aspect of the present invention, there is provided an image processing method with which to process an image, the processing method comprising the steps of acquiring an image of a plurality of areas of which two adjacent areas have different image characteristics from each other; and analyzing the image with using the difference between image characteristics of the two adjacent areas to obtain information about a boundary between the two adjacent areas.

In the image processing method of this invention, the image includes first and second areas which have intrinsic image patterns different from each other and between which the boundary cannot be detected as a continuous line based on the differences between individual pixel data, and the analyzing step may comprise the steps of calculating a texture characteristic's value in each position of a texture analysis window of a predetermined size based on pixel data in the texture analysis window, while moving the texture analysis window; and estimating a boundary between the first and second areas based on a distribution of the texture characteristic's values calculated in the step of calculating a texture characteristic's value.

In this case, in the step of calculating a texture characteristic's value, are calculated the texture characteristic's values in the case where only the intrinsic pattern of the first area is present in the texture analysis window, the texture characteristic's values in the case where only the intrinsic pattern of the second area is present in the texture analysis window, and the texture characteristic's values in the case where the intrinsic patterns of the first and second areas are present in the texture analysis window. The way that the texture characteristic's value varies (or does not vary) differs between the above cases. Therefore, by analyzing a distribution of the texture characteristic's values in the step of estimating a boundary, the boundary between the first and second areas can be accurately estimated as a continuous line.

Here, at least one of intrinsic patterns of the first and second areas may be known. In this case, by setting the size of the texture analysis window to such a size that the texture characteristic's value varies in a predetermined way (or does not vary at all) in the known intrinsic pattern area and identifying an area where the texture characteristic's value does not vary in the predetermined way, the boundary between the first and second areas can be accurately estimated as a continuous line.

In this case, the size of the texture analysis window may be determined according to the known intrinsic pattern.

In the case of performing texture analysis in the image processing method of this invention, when it is known that a specific area is a part of the first area in the image, the step of calculating a texture characteristic's value may comprise the steps of calculating the texture characteristic's value while changing a position of the texture analysis window in the specific area and examining how the texture characteristic's value in the specific area varies according to the position of the texture analysis window; and calculating the texture characteristic's value while changing a position of the texture analysis window outside the specific area.

In this case, in the examining step, a texture characteristic's value is obtained while a changing a position of the texture analysis window, and how the texture characteristic's value in the specific area varies according to a position of the texture analysis window is examined. The way that the texture characteristic's value varies in the specific area obtained as examination results reflects the intrinsic pattern of the first area including the specific area. Therefore, after calculating the texture characteristic's value while changing a position of the texture analysis window outside the specific area in the step of calculating a texture characteristic's value outside the specific area, by identifying an area different from the specific area in the above step of estimating a boundary, the boundary between the first and second areas can be accurately estimated.

In the case of performing texture analysis in the image processing method of this invention, when it is known that a specific area is a part of the first area in the image, the step of calculating a texture characteristic's value may comprise the steps of calculating the texture characteristic's value while changing a position and size of the texture analysis window in the specific area; and calculating a size of the texture analysis window with which the texture characteristic's value is substantially constant regardless of a position of the texture analysis window in the specific area.

In this case, in the step of calculating a texture characteristic's value in the specific area, the texture characteristic's value is calculated while changing a position and size of the texture analysis window in the specific area. Subsequently, in the step of calculating a size of the texture analysis window, for each size of the texture analysis window, the way that the texture characteristic's value varies according to a position of the texture analysis window is examined to obtain a size of the texture analysis window with which the texture characteristic's value is substantially constant. The size of the texture analysis window which has been obtained in this manner reflects the intrinsic pattern of the first area including the specific area. Therefore, after calculating the texture characteristic's value while moving texture analysis window of the obtained size outside the specific area and changing a position of the texture analysis window, by identifying areas where the texture characteristic's value varies greatly in the above step of estimating a boundary, the boundary between the first and second areas can be accurately estimated.

In the case of performing texture analysis according to the image processing method of this invention, the texture characteristic's value may be at least one of mean and variance of pixel data in the texture analysis window.

Further, in the case of performing texture analysis according to the image processing method of this invention, when weight information for pixels in the texture analysis window is predetermined according to respective distances of the pixels from the center of the texture analysis window, in the step of calculating a texture characteristic's value, a texture characteristic's value of an image in the texture analysis window may be calculated based on the weight information and image data of the pixels.

In this case, in the step of calculating a texture characteristic's value, a texture characteristic's value of an image in the texture analysis window is calculated based on known weight information and image data of the pixels. As a result, the texture characteristic's value can be obtained without or with little dependence of sensitivity on directions from a center position of the texture analysis window. It is understood that when setting weight information, if a circle whose center coincides with a center position of a texture analysis window is within the texture analysis window, a same weight determined according to a radius of the circle is set as appropriate for respective pixels on the circumference of the circle. Meanwhile, when a part of the circle is outside of the texture analysis window, if the part outside of the texture analysis window is large, weight for respective pixels on the circumference is set to be small (“0” is a lower limit).

Here, the texture analysis window may be a square, and the weight information may include intrinsic weight information which contains a ratio of a whole area of a rectangular sub-area and an area of an inscribed circle area of the texture analysis window, an area in the texture analysis window being divided into the rectangular sub-areas corresponding to respective pixels.

In this case, pixels are weighted using isotropic intrinsic weight information that weights for pixels around the texture analysis window's center are about 1, weights for pixels in the four corners are about 0, and weights for other pixels including ones on the sides are between 1 and 0. That is, a pixel whose distance from the center is greater than half of a side of the texture analysis window contributes less to the texture characteristics value. As a result, a contribution to the texture characteristic's value of a pixel on the circumference of a circle whose part is outside the texture analysis window is reasonably reduced from the isotropic point of view. Therefore, texture analysis can be easily and speedily performed with isotropic sensitivity.

Here, the weight information may further include additional weight information according to the type of texture analysis. In this case, texture analysis can be performed in accordance with types of texture analysis while maintaining isotropic sensitivity.

In the image processing method of this invention, in the case of considering weight information in accordance with a position of the texture analysis window, the texture characteristic's value may be at least one of weighted mean and weighted variance of pixel data in the texture analysis window.

Yet further, in the image processing method of this invention, when the image is an image having no fewer than three tones that includes first and second areas which are different from each other in brightness of pixels in the vicinity of the boundary, the analyzing step may comprise the steps of calculating a threshold to discriminate first and second areas in the image from a distribution of brightness of the image; and estimating a position at which the brightness is estimated to be equal to the threshold in the brightness distribution of the image to be a boundary position between the first and second areas.

According to this, from brightness distribution of the image, in the step of calculating a threshold, a threshold to discriminate object and background areas is calculated. For example, when brightness of one pixel in the image is one of data and whole data in the image is divided into data groups of object area and data groups of background area, the threshold is calculated as a data value that minimizes the sum of randomness in each group of data, (hereinafter this method is called an “entropy method”). It is remarked that in order to calculate a threshold, other discriminant analysis methods than the entropy method, and statistical methods such as a method which obtains the middle value between the mean of brightness in an area surely included in the object area and the mean of brightness in an area surely included in the background area can be used.

After the calculation of the threshold, in the step of estimating a boundary, a position where brightness is estimated to be equal to the threshold from brightness distribution of the image is estimated to be a boundary position between the first and second areas (e.g. a position of an outer edge of the object). As a result, position information on the boundary can be obtained with accuracy on a sub-pixel scale (accuracy of a sub-pixel level), which is much higher than accuracy on a pixel scale (accuracy of a pixel level).

Here, when the image is a set of brightness of a plurality of pixels arranged two-dimensionally along first and second directions, the step of estimating a boundary position may comprise the step of estimating a first estimated boundary position in the first direction based on brightness of first and second pixels that have a first magnitude relation and are adjacent to each other in the first direction in the image, and the threshold.

In this case, the first magnitude relation may be a relation where one of a first condition and a second condition is fulfilled, in the first condition brightness of the first pixel being greater than the threshold and brightness of the second pixel being not greater than the threshold, and in the second condition brightness of the first pixel being not less than the threshold and brightness of the second pixel being less than the threshold.

Here, the first estimated boundary position may be at a position which divides internally a line segment joining the centers of the first and second pixels in proportion to an absolute value of difference between brightness of the first pixel and the threshold, and an absolute value of difference between brightness of the second pixel and the threshold.

In the image processing method of this invention, when the first magnitude relation is used, the step of estimating a boundary position may further comprise the step of estimating a second estimated boundary position in the second direction based on brightness of third and fourth pixels that have a second magnitude relation and are adjacent to each other in the second direction in the image, and the threshold.

Here, the second magnitude relation may be a relation where one of a third condition and a fourth condition is fulfilled, in the third condition brightness of the third pixel being greater than the threshold and brightness of the fourth pixel being not greater than the threshold, and in the fourth condition brightness of the third pixel being not less than the threshold and brightness of the fourth pixel being less than the threshold.

In this case, the second estimated boundary may be at a position which divides internally a line segment joining the centers of the third and fourth pixels in proportion to an absolute value of difference between brightness of the third pixel and the threshold, and an absolute value of difference between brightness of the fourth pixel and the threshold.

Still further, in the image processing method of this invention, when the image has no fewer than three areas divided by no fewer than three boundary lines extending radially from a specific point, the analyzing step may includes the steps of preparing a template pattern that includes at least three line pattern elements extending from a reference point, and when the reference point coincides with the specific point the at least three line pattern elements extend through respective areas of the no fewer than three areas and have level values corresponding to predicted level values of the respective areas; and calculating a correlation value between the image and the template pattern in each position of the image, while moving the template pattern in the image.

In this case, in estimating a boundary when the image has no fewer than three areas divided by no fewer than three boundary lines extending radially from a specific point, first, in the step of preparing a template pattern, a template pattern that includes at least three line pattern elements is obtained, the at least three line pattern elements extending from the reference point through the respective areas of the no few than three areas of a mark when the reference point coinciding with the specific point. Here, respective line pattern elements are set to have level values corresponding to predicted level values of the respective areas For example, a magnitude relation between level values of line pattern elements is set to be a same magnitude relation as the respective areas are predicted to have. That is, when a predicted level value of one area of the respective areas is greater than (, equal to or less than) predicted level values of other respective areas, a predicted level value of one line pattern which corresponds to the one area is set to be greater than (, equal to or less than) predicted level values of other line patterns.

Subsequently, in the step of calculating a correlation value, while moving the prepared template pattern, a correlation value between the image and the template pattern in each position of the image is calculated. In the calculation of the correlation value in each position, because the template pattern has the plurality of one-dimensional line patterns, computational effort is far less than in the case of using a planar template pattern. Further, even if the object has been slightly rotated, the relation between the line patterns and the corresponding respective areas when the reference point coincides with the specific point is ensured. Therefore, the correlation value can be calculated more quickly than in the conventional methods.

Here, each of the line pattern elements may extend along a bisector of an angle predicted to be made by boundary lines of the respective areas in the image.

Further, the numbers of the no fewer than three boundary lines and the no fewer than three areas may be four, and out of the four boundary lines, two boundary lines may be substantially on a first straight line, and the other two boundary lines are substantially on a second straight line.

In this case, the first and second straight lines may be perpendicular to each other.

Further, the number of the line pattern elements may be four.

Here, among the four areas in the image, adjacent two areas may be different from each other in level value, and two areas diagonal across the specific point may be substantially the same in level value.

Further, level values of the line pattern elements may have a same magnitude relation as a magnitude relation of level values that the respective areas in the image are predicted to have.

According to a second aspect of the present invention, there is provided an image processing unit which processes an image, the processing unit comprising an image acquiring unit that acquires an image of a plurality of areas of which two adjacent areas have different image characteristics from each other; and an image analyzing unit that analyzes the image with using the difference between image characteristics of the two adjacent areas to obtain information about a boundary between the two adjacent areas.

In the image processing unit according to this invention, when the image includes first and second areas which have intrinsic image patterns different from each other and between which the boundary cannot be detected as a continuous line based on the differences between individual pixel data, the image analyzing unit may comprise a characteristic value calculating unit that calculates a texture characteristic's value in each position of a texture analysis window of a predetermined size based on pixel data in the texture analysis window, while moving the texture analysis window; and a boundary estimating unit that estimates the boundary between the first and second areas based on a distribution of the texture characteristic's values calculated by the characteristic value calculating unit.

In this case, the characteristic value calculating unit calculates the texture characteristic's values in the case where only the intrinsic pattern of the first area is present in the texture analysis window, the texture characteristic's values in the case where only the intrinsic pattern of the second area is present in the texture analysis window, and the texture characteristic's values in the case where the intrinsic patterns of the first and second areas are present in the texture analysis window. And the boundary estimating unit analyzes a distribution of the texture characteristic's values to estimate the boundary between the first and second areas. That is, the image processing unit according to the present invention estimates the boundary of the first and second areas with the image processing method according to the present invention. Therefore, the boundary between the first and second areas can be accurately estimated as a continuous line.

Here, when at least one of intrinsic patterns of the first and second areas is known, the characteristic value calculating unit may calculate the texture characteristic's value while moving the texture analysis window whose size has been determined according to the known intrinsic pattern. In this case, the characteristic value calculating unit calculates the texture characteristic's value while moving the texture analysis window whose size has been set to such a size that the texture characteristic's value varies in a predetermined way in the known intrinsic pattern area. In a distribution of the texture characteristic's values obtained in this manner, the boundary estimating unit identifies an area where the texture characteristic's value varies in a way different from the predetermined way, so that it can accurately estimate the boundary between the first and second areas.

Further, when it is known that a specific area is a part of the first area in the image, the characteristic value calculating unit may obtain a size of the texture analysis window with which the texture characteristic's value is substantially constant regardless of a position of the texture analysis window in the specific area and calculate the texture characteristic's value while moving the texture analysis window of the obtained size.

In this case, the characteristic value calculating unit calculates the texture characteristic's value while changing a position and size of the texture analysis window in the specific area. Subsequently, for each size of the texture analysis window, the way that the texture characteristic's value varies according to a position of the texture analysis window is examined to obtain a size of the texture analysis window with which the texture characteristic's value is substantially constant. Subsequently, the characteristic value calculating unit calculates the texture characteristic's value while moving the texture analysis window of the obtained size outside the specific area and changing a position of the texture analysis widow. And the boundary estimating unit accurately estimates the boundary between the first and second areas by identifying areas where the texture characteristic's value varies greatly.

Further, the characteristic value calculating unit may comprise a weight information computing unit that obtains weight information for pixels in the texture analysis window according to respective distances of the pixels from the center of the texture analysis window, and a weighted characteristic value calculating unit that calculates a texture characteristic's value of an image in the texture analysis window based on the weight information and image data of the pixels.

According to this, the weight information computing unit obtains weight information containing weights of pixels which have the same distance from the center of the texture analysis window being the same weights, and the characteristic value calculating unit calculates a texture characteristic's value of an image in the texture analysis window based on the weight information obtained by the weight information computing unit and image data of the pixels. That is, the image processing unit of this invention performs image processing by using the image processing method of this invention. Therefore, texture analysis can be performed with isotropic sensitivity, and image processing which requires analysis with respect to various directions can be performed accurately with high tolerance to noise.

Here, the texture analysis window may be a square, and the weight information computing unit may comprise a intrinsic weight calculating unit that calculates intrinsic weight information which corresponds to a ratio of an inscribed circle area of the texture analysis window to a whole area of a rectangular sub-area in each rectangular sub-area, the texture analysis window being divided into the rectangular sub-areas according to respective pixels in the image. In this case, the intrinsic weight calculating unit calculates intrinsic weight information which is simple and reasonable as weight information to perform texture analysis with isotropic sensitivity. Therefore, texture analysis can be easily and speedily performed with isotropic sensitivity.

In the image processing unit according to this invention, when the image is an image having no fewer than three tones that includes first and second areas which are different from each other in brightness of pixels in the vicinity of the boundary, the image analyzing unit may comprise a threshold calculating unit that calculates a threshold to discriminate first and second areas in the image from a distribution of brightness of the image; and a boundary position estimating unit that estimates a position at which the brightness is estimated to be equal to the threshold based on a brightness distribution of the image to be a boundary position between the first and second areas.

According to this, a threshold calculating unit calculates a threshold to discriminate first and second areas from the brightness distribution of the image. And a boundary estimating unit estimates a continuous distribution of brightness from a discrete distribution of brightness in the image, and estimates a position at which brightness is estimated to be equal to the threshold in the continuous distribution to be a boundary between the first and second areas. Therefore, the boundary position can be estimated with accuracy on a sub-pixel scale (accuracy of a sub-pixel level), which is much higher than accuracy on a pixel scale (accuracy of a pixel level).

In the image processing unit according to this invention, when the image has no fewer than three areas divided by no fewer than three boundary lines extending radially from a specific point, the image analyzing unit may comprise a template preparing unit that prepares a template pattern that includes at least three line pattern elements extending from a reference point, and when the reference point coincides with the specific point, the at least three line pattern elements extend through respective areas of the no fewer than three areas and have level values corresponding to predicted level values of the respective areas; and a correlation calculating unit that calculates a correlation value between the image and the template pattern in each position of the image, while moving the template pattern in the image.

According to this, the correlation calculating unit calculates a correlation value between the image and the template pattern in each position of the image using a template pattern stored in a storage unit, while moving the template pattern. Here, a mark has no fewer than three areas divided by no fewer than three boundary lines extending radially from a specific point, and a template pattern including at least three line pattern elements is used, the at least three line pattern elements extending through respective areas of the no fewer than three areas of the mark and having level values corresponding to predicted level values that the respective areas is predicted to have when the image of the mark is picked up, when the reference point coinciding with the specific point of the mark. Therefore, the correlation value can be calculated more quickly, compared to the conventional image processing units.

In the image processing unit according to this invention, the image acquiring unit may be an image picking up unit.

According to a third aspect of the present invention, there is provided a detecting method with which to detect characteristic information of an object based on a distribution of light through the object when illuminating the object, the detecting method comprising the steps of processing an image formed by the light through the object with the image processing method according to the present invention; and detecting characteristic information of the object based on the processing result of the step of processing an image.

According to this, in the step of processing an image, image processing is performed by using the image processing method according to the present invention, and the estimation of the boundary in the image is accurately performed. Further, in the detecting step characteristic information of the object is detected based on the result of processing the image. Therefore, the characteristic information of the object can be accurately detected.

In the detecting method of this invention, the characteristic information of the object may be shape information of the object.

Further, in the detecting method of this invention, the characteristic information of the object may be position information of the object.

Yet further, in the detecting method of this invention, when the object is at least one optical element, the characteristic information of the object may be optical characteristic information of the at least one optical element.

According to a fourth aspect of the present invention, there is provided a detecting unit which detects characteristic information of an object based on a distribution of light through the object when illuminating the object, the detecting unit comprising an image processing unit according to the present invention, which processes an image formed by the light through the object; and a characteristic detecting unit that detects characteristic information of the object based on the processing result of the image processing unit.

According to this, an image processing unit of this invention processes an image to accurately estimate a boundary in the image, and a characteristic detecting unit detects characteristic information of the object based on the result of processing the image. Therefore, characteristic information of the object can be detected accurately.

In the detecting unit of this invention, the characteristic information of the object may be shape information of the object.

Further, in the detecting unit of this invention, the characteristic information of the object may be position information of the object.

Still further, in the detecting unit of this invention, when the object includes at least one optical element, the characteristic information of the object may be optical characteristic information of the at least one optical element.

According to a fifth aspect of the present invention, there is provided an exposure method with which to transfer a given pattern onto a substrate, the exposure method comprising the steps of detecting position information of the substrate with the detecting method according to this invention; and transferring the given pattern onto the substrate while controlling a position of the substrate based on the position information of the substrate detected in the step of detecting position information. According to this, in the detecting step, position information of the substrate subject to exposure is accurately detected by using the detecting method of this invention. And, in the transferring step, the substrate is exposed while controlling a position of the substrate is controlled based on the detected position information, and the given pattern is transferred onto the substrate. Therefore, the given pattern can be accurately transferred onto a substrate.

According to a sixth aspect of the present invention, there is provided an exposure method with which to transfer a given pattern onto a substrate by illuminating with an exposure beam via an optical system, the exposure method comprising the steps of detecting optical characteristic information of the optical system with the detecting method according to this invention; and transferring the given pattern onto the substrate based on the detecting result of the step of detecting optical characteristic information. According to this, in the detecting step, optical characteristic information of the optical system is accurately detected by using the detecting method of this invention, and in the transferring step, the substrate is exposed based on the detected characteristic information and the given pattern is transferred onto the substrate. Therefore, the given pattern can be accurately transferred onto a substrate.

According to a seventh aspect of the present invention, there is provided an exposure apparatus which transfers a given pattern onto a substrate, the exposure apparatus comprising a detecting unit according to this invention, which detects position information of the substrate; and a stage unit that has a stage on which the substrate is mounted, the position information of the substrate being detected by the detecting unit. According to this, a detecting unit according to this invention accurately detects position information of the substrate subject to exposure, and by mounting the substrate which position information has been detected in this manner on the stage of the stage unit to perform position control, a position of the substrate is accurately controlled. Therefore, the given pattern can be accurately transferred by exposing a substrate whose position is accurately controlled.

According to an eighth aspect of the present invention, there is provided an exposure apparatus which transfers a given pattern onto a substrate by illuminating with an exposure beam, the exposure apparatus comprising an optical system that guides the exposure beam to the substrate; and a detecting unit according to this invention, which detects characteristic information of the optical system. According to this, a detecting unit of this invention accurately detects characteristic information of the optical system that guides the exposure beam to the substrate. Therefore, the given pattern can be accurately transferred onto a substrate by performing exposure on the substrate using the optical system whose characteristic has been accurately detected, and adjusting exposure parameters based on the characteristic of the optical system.

### BRIEF DESCRIPTION OF THE DRAWINGS

FIG. 1 is a schematic view showing the construction of an exposure apparatus according to a first embodiment;

FIG. 2 is a schematic view showing the construction of a light source image pick-up unit and its neighborhood in FIG. 1;

FIG. 3 is a plan view schematically showing the construction of a pre-alignment detection system and its neighborhood in FIG. 1;

FIG. 4 is a block diagram showing the construction of a main control system of the apparatus in FIG. 1;

FIG. 5 is a block diagram showing the construction of a wafer shape computing unit and a wafer shape computation data store area in FIG. 4;

FIG. 6 is a block diagram showing the construction of a shape of light source image computing unit and a shape of light source image computation data store area in FIG. 4;

FIG. 7 is a flow chart for explaining the operation of the apparatus in FIG. 1;

FIG. 8 is a flow chart for explaining the process of an illumination σ measurement subroutine in FIG. 7;

FIG. 9 is a view for explaining the optical arrangement when picking up a light source image;

FIGS. 10A to 10C are views for explaining the result of picking up a light source image;

FIG. 11 is a flow chart for explaining the process of a texture analysis subroutine in FIG. 8;

FIGS. 12A and 12B are views for explaining the process of calculating weight information;

FIGS. 13A and 13B are views for explaining the initial and final positions of a texture analysis window;

FIGS. 14A and 14B are views for explaining variance as a function of position from measurement of illumination a;

FIGS. 15A to 15C are views for explaining the picking-up results of the pre-alignment detection system;

FIG. 16 is a flow chart for explaining the process of a wafer shape measurement subroutine;

FIGS. 17A to 17C are views for explaining examples of position of the texture analysis window;

FIGS. 18A to 18C are views for explaining variance as a function of position from measurement of a wafer's shape and the estimated outer edge of the wafer;

FIG. 19 is a view for explaining a modified example of weight information;

FIG. 20 is a plan view schematically showing the construction of a pre-alignment detection system and its neighborhood in the second embodiment;

FIG. 21 is a block diagram showing the construction of a main control system in the second embodiment;

FIGS. 22A to 22C are views for explaining the picking-up results of the pre-alignment detection system;

FIG. 23 is a flow chart for explaining the process of a wafer shape measurement subroutine;

FIG. 24 is a flow chart for explaining the process of a threshold calculating subroutine in FIG. 23;

FIGS. 25A and 25B are views for explaining calculation of a threshold by use of a least-entropy method;

FIGS. 26A and 26B are views for explaining the principle of estimating the position of an outer edge in the second embodiment (part 1);

FIGS. 27A and 27B are views for explaining the principle of estimating the position of an outer edge in the second embodiment (part 2);

FIG. 28 is a flow chart for explaining the process of an outer edge position estimation subroutine in FIG. 23;

FIG. 29 is a view for explaining the size and arrangement of pixels in a pickup field;

FIG. 30 is a block diagram showing the construction of a main control system in the third embodiment;

FIG. 31 is a flow chart for explaining the exposure operation in the third embodiment;

FIG. 32 is a flow chart for explaining the process of a correction subroutine in FIG. 31;

FIGS. 33A and 33B are views for explaining the construction of a measurement wafer;

FIGS. 34A to 34C are views for explaining the results of picking up an image of the measurement wafer; and

FIG. 35 is a view for explaining a template pattern.

### DESCRIPTION OF THE PREFERRED EMBODIMENTS

<<A First Embodiment>>

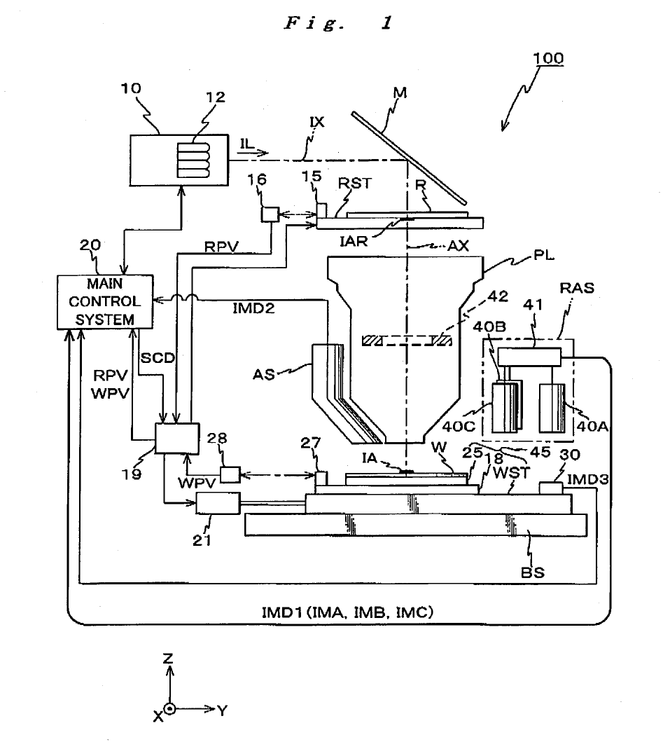

A first embodiment of the present invention will be described below with reference to FIGS. 1 to 18.

FIG. 1 shows the schematic construction and arrangement of an exposure apparatus 100 according to this embodiment, which is a projection exposure apparatus of a step-and-scan type.

This exposure apparatus 100 comprises an illumination system 10 emitting exposure illumination light as an exposure beam, a reticle stage RST for holding a reticle R, a projection optical system PL as an optical system, a wafer stage 45 as a stage unit on which a substrate table 18 is mounted that moves two-dimensionally on an X-Y plane with holding a wafer W as a substrate, a pre-alignment detection system RAS as a pick-up unit for picking up the outer shape of the wafer W, an alignment detection system AS for viewing marks formed on the wafer W, a light source image pick-up unit 30 as a pick-up unit for picking up light source images on the entrance pupil plane of the projection optical system PL, and a control system for controlling these.

The illumination system 10 comprises a light source unit, a shutter, an optical integrator 12, a beam splitter, a collective lens system, a reticle blind, an imaging lens system, and the like (none are shown except for the fly-eye array lens 12). As the optical integrator, a fly-eye lens, an inner-surface-reflective-type integrator (rod integrator, etc.) or a diffractive optical element is used. The construction of the illumination system 10 is disclosed in, for example, Japanese Patent Application Laid-Open No. 10-112433 and U.S. Pat. No. 5,502,311 corresponding thereto. The disclosure in the above Japanese Patent Application Laid-open and U.S. Patent is incorporated herein by reference as long as the national laws in designated states or elected states, to which this international application is applied, permit.

Here, as the light source unit, an excimer laser such as KrF excimer laser (with a wavelength of 248 nm) or ArF excimer laser (with a wavelength of 193 nm), F₂ laser (with a wavelength of 157 nm), Ar₂ laser (with a wavelength of 126 nm), a harmonic wave generator using a copper vapor laser or YAG laser, an ultra high pressure mercury lamp (g-line, i-line, etc.), or the like is used.

The operation of the illumination system 10 having such construction will be briefly described in the following. The illumination light emitted from the light source unit is made incident on the optical integrator when the shutter is open. For example, when a fly-eye lens is used as the optical integrator, a surface light source (hereinafter called a “illuminant image”) composed of a lot of light source images, i.e. a secondary light source, is formed on a focus plane on the exit side. The illumination light sent from the optical integrator reaches the reticle blind through the beam splitter and collective lens system, and, after having passed through the reticle blind, is sent toward a mirror M through the imaging lens system.

After that, the illumination light IL is deflected vertically downwards by the mirror M and illuminates a rectangular illumination area IAR on a reticle R held on the reticle stage RST.

On the reticle stage RST, a reticle R is fixed by, e.g., vacuum chuck. The reticle stage RST is constructed to be able to be driven finely and two-dimensionally (in X and Y directions and rotationally about a Z axis perpendicular to an X-Y plane) on the X-Y plane perpendicular to the optical axis IX (coinciding with the optical axis AX of a projection optical system PL) of the illumination system 10 in order to position the reticle R.

Further, the reticle stage RST can be driven at specified scanning speed in a predetermined scanning direction (herein, parallel to the Y direction) on a reticle base (not shown) by a reticle stage driving unit (not shown) constituted by a linear motor, etc., and has such a movement stroke that the optical axis IX of the illumination system crosses at least the whole area of the reticle R.

Fixed on the reticle stage RST is a movable mirror 15 that reflects the laser beam from a reticle laser interferometer 16 (hereinafter, referred to as a “reticle interferometer”), and the position of the reticle stage RST in the plane where the stage moves is always detected by the reticle interferometer 16 with resolving power of, e.g., about 0.5 to 1 nm. In practice, provided on the reticle stage RST are a movable mirror (or at least one corner-cube-type mirror) having a reflective surface perpendicular to the scanning direction (Y direction) and a movable mirror having a reflective surface perpendicular to the non-scanning direction (X direction), and the reticle interferometer 16 has a plurality of axes in each one of the scanning and non-scanning directions, as representatively shown by the movable mirror 15 and the reticle interferometer 16 in FIG. 1. Incidentally, for example, the end face of the reticle stage RST may be processed to be reflective to form the reflective surface.

The position information (or speed information) RPV of the reticle stage RST is sent from the reticle interferometer 16 through the stage control system 19 to the main control system 20, and the stage control system 19, according to instructions from the main control system 20, drives the reticle stage RST via the reticle stage driving portion (not shown) based on the position information (or speed information) RPV of the reticle stage RST.

It is remarked that because the reticle stage RST is moved to such an initial position that the reticle R is accurately positioned in a predetermined reference position by a reticle alignment system (not shown), the position of the reticle R is measured accurately enough only by measuring the position of the movable mirror 15 by means of the reticle interferometer 16.

The projection optical system FL is held by a main body column (not shown) underneath the reticle R, of which system the optical axis is parallel to the z axis, and which comprises a plurality of lens elements (refractive optical elements) arranged a predetermined distance apart from each other along the optical axis and a lens barrel holding these lens elements, and the pupil plane of the projection optical system is conjugate to the secondary light source and has a positional relation of fourier transformation with the surface of the reticle R. Further, an aperture stop 42 is provided near the pupil plane, and by changing the aperture's size thereof, the numerical aperture (N.A.) of the projection optical system PL can be freely adjusted. By changing the aperture diameter of an iris stop herein used as the aperture stop 42 by means of a stop driving mechanism (not shown), which is controlled by the main control system 20, the numerical aperture of the projection optical system PL can be changed within a predetermined range. Herein, the aperture diameter of the aperture stop 42 is set at D_{P}.

Diffracted light having passed through the aperture stop 42 contributes to the imaging on the wafer W conjugate to the reticle R.

Therefore, when the illumination area of the reticle R is illuminated with the illumination light IL from the illumination system, the reduced image of the circuit pattern's part in the illumination area IAR on the reticle R is, with a predetermined reduction ratio, e.g. 1/4 or 1/5, projected and formed by the illumination light IL having passed through the reticle R and the projection optical system PL on the wafer W coated with a resist (photosensitive material), the reduced image being an inverted image.

The wafer stage WST is constructed to be able to be finely moved on a base BS in the scanning direction, the Y direction (the lateral direction in FIG. 1), and in the X direction (a direction perpendicular to the drawing of FIG. 1) perpendicular to the Y direction by, e.g., a two-dimensional linear actuator. Mounted on the wafer stage WST is a substrate table 18 on which a wafer holder 25 holding a wafer W by vacuum chuck is provided. The wafer stage WST, the substrate table 18, and the wafer holder 25 compose a substrate stage unit 45.

The substrate table 18 is positioned and fixed on the wafer stage WST such that it can be moved in the Z direction and can be tilted, and is supported at three different points by three axes (not shown) each of which is driven independently and in the Z direction by a wafer stage driving unit 21 as a driving mechanism such that the surface position (position in the Z direction and tilt to the X-Y plane) of a wafer W held on the substrate table 18 is set to a desired state. Further, the wafer holder 25 can be rotated about the Z axis, and therefore the wafer holder 25 is driven in six degree of freedom directions by the two-dimensional linear actuator and the driving mechanism that are representatively indicated by the wafer stage driving unit 21 in FIG. 1.

Fixed on the substrate table 18 is a movable mirror 27 for reflecting the laser beam from a wafer laser interferometer 28 (hereinafter, referred to as a “wafer interferometer”), and the position of the substrate table 18 in the X-Y plane is always detected by the wafer interferometer 28 with resolving power of, e.g., about 0.5 to 1 nm.

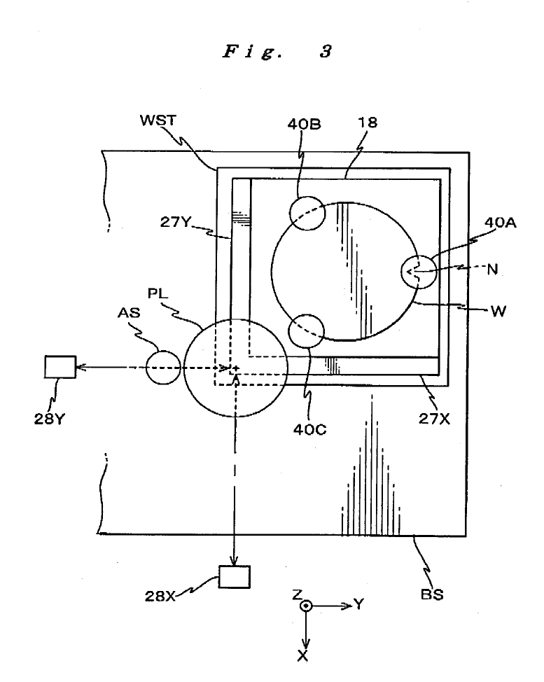

Here, in reality, as shown in FIG. 3, provided on the substrate table 18 are a movable mirror 27X having a reflective surface perpendicular to the scanning direction (Y direction) and a movable mirror 27Y having a reflective surface perpendicular to the non-scanning direction (X direction), and the wafer interferometer 28 has wafer interferometers 28X and 28Y that have a plurality of measurement axes in the X and Y directions respectively, as representatively shown by the movable mirror 27 and the wafer interferometer 28 in FIG. 1. Incidentally, for example, the end face of the substrate table 18 may be processed to be reflective to form the reflective surface. The position information (or speed information) WPV of the substrate table 18 (thus position information or speed information of the wafer W and the wafer stage WST) is sent through the stage control system 19 to the main control system 20, and based on the position information (or speed information) WPV, the stage control system 19, according to instructions from the main control system 20, controls the movement of the wafer stage WST via the wafer stage driving portion 24. The main control system 20 and the stage control system 19 compose the control system.

Moreover, fixed on the substrate table 18 is a reference mark plate (not shown) on which various reference marks for base line measurement, etc., are formed in which measurement the distance between the detection center of the alignment detection system AS of an off-axis-type later described and the optical axis of the projection optical system PL is measured.

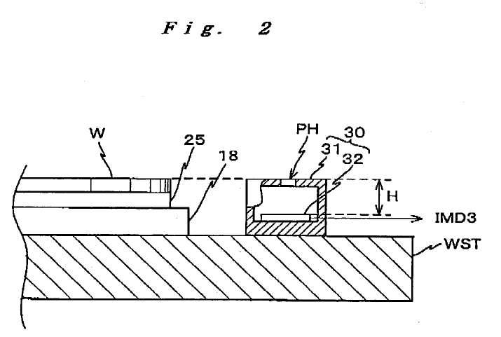

In addition, disposed on the wafer stage WST is the light source image pick-up unit 30 as an illumination σ sensor for picking up an image on the entrance pupil plane of the projection optical system PL corresponding to the illuminant image, and the light source image pick-up unit 30, as shown in FIG. 2, comprises a container 31 whose upper face is at the same Z position as the surface of the wafer W held on the wafer holder 25 and has a pinhole PH formed thereon and a two-dimensional pick-up device 32 fixed on the inner bottom of the container. Here, the light receiving face of the two-dimensional pick-up device 32 is positioned at a position a distance H in the Z direction below the upper face of the container 31 so as to be conjugate to the pupil plane of the projection optical system PL. It is assumed that a projection ratio β_{S} with which an image on the entrance pupil plane is projected onto the light receiving face of the two-dimensional pick-up device 32 is known.

Referring back to FIG. 1, the pre-alignment detection system RAS is held above the base BS and apart from the projection optical system PL by a holding member (not shown), and comprises three pre-alignment sensors 40A, 40B, 40C for detecting three positions on the periphery of a wafer w which has been transported by a wafer loader (not shown) and is held on the wafer holder 25 and a pre-alignment control unit 41 for processing pick-up result data IMA, IMB, IMC from the respective pre-alignment sensors 40A, 40B, 40C.

These three pre-alignment sensors 40A, 40B, 40C, as shown in FIG. 3, are arranged an angular distance of 120 degrees apart from each other on a circle having a predetermined radius (almost equal to the radius of the wafer W). One of them, herein the pre-alignment sensor 40A, is disposed in a position where it can detect a V-shaped notch N of the wafer W on the wafer holder 25. The pre-alignment sensor is a CCD camera as an image-processing-type sensor composed of a pick-up device such as CCD and an image processing circuit or the like. Hereinafter, the pre-alignment sensors 40A, 40B, 40C are also called CCD cameras 40A, 40B, 40C.

The pre-alignment control unit 41 comprises an image processing system that, under the control of the main control system 20, collects pick-up result data IMA, IMB, IMC from the CCD cameras 40A, 40B, 40C and sends image data IMD1 including them to the main control system 20

Incidentally, before the wafer W is transferred onto the wafer holder 25, that is, while it is held by the wafer loader, the pre-alignment detection system RAS may pick up the images of three parts on the periphery of the wafer W.

The alignment detection system AS is disposed on the side face of the projection optical system PL, and in this embodiment is an alignment microscope of an off-axis-type having an imaging alignment sensor that views street lines or position detection marks (fine alignment marks) formed on the wafer W. The construction of this alignment detection system AS is disclosed in detail in, for example, Japanese Patent Application Laid-Open No. 9-219354 and U.S. Pat. No. 5,859,707 corresponding thereto. The disclosure in the above Japanese Patent Application Laid-Open and U.S. Patent is incorporated herein by reference as long as the national laws in designated states or elected states, to which this international application is applied, permit. Image data IMD2, the result of the alignment detection system AS viewing the wafer W, is supplied to the main control system 20.

The apparatus in FIG. 1 further comprises a multi focus position detection system (not shown) that is of an oblique-incidence type that detects the position in the Z direction (optical axis direction) of the wafer W's surface at measurement points in and around a projection area IA on the wafer W (conjugate to the illumination area IAR). This multi focus position detection system comprises an illumination optical system having an optical fiber bundle, a collective lens, a pattern forming plate, a lens, a mirror, and an objective lens and a light receiving optical system having an objective lens, a rotationally vibrating plate, an imaging lens, a slit plate for receiving light, and a light receiving unit composed of a lot of photo sensors (none are shown). The construction of this multi focal detection system is disclosed in detail in, for example, Japanese Patent Application Laid-Open No. 6-283403 and U.S. Pat. No. 5,448,332 corresponding thereto. The disclosure in the above Japanese Patent Application Laid-Open and U.S. Patent is incorporated herein by reference as long as the national laws in designated states or elected states, to which this international application is applied, permit.

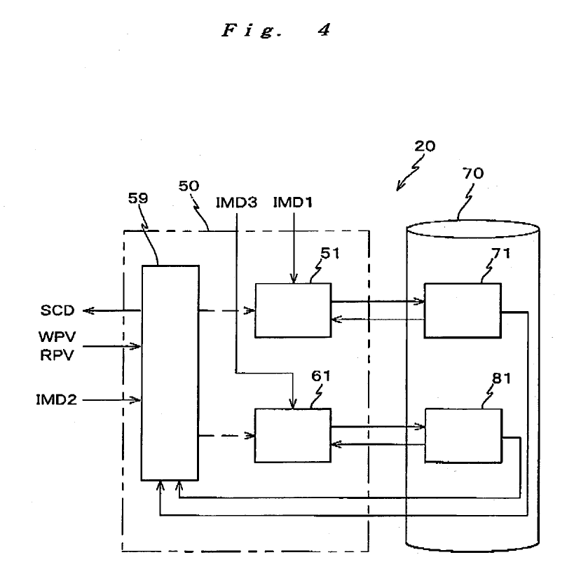

The main control system 20, as shown in FIG. 4, comprises a main controller 50 and a storage unit 70. The main controller 50 comprises (a) a controller 59 for controlling the overall operation of the exposure apparatus 100 by, among other things, supplying stage control data SCD based on the position information (or speed information) RPV, WPV of the reticle R and the wafer W, (b) a wafer shape computing unit 51 for measuring the outer shape of the wafer W by using image data IMD1 from the pre-alignment detection system RAS, to detect the center position and radius of the wafer W, and (c) a shape of light source image computing unit 61 for measuring the outer shape of the illuminant image by using image data IMD3 from the light source image pick-up unit 30, to detect the center position and radius of the illuminant image. The storage unit 70 comprises a wafer shape computation data store area 71 for storing data generated by the wafer shape computing unit 51 and a shape of light source image computation data store area 81 for storing data generated by the shape of light source image computing unit 61.

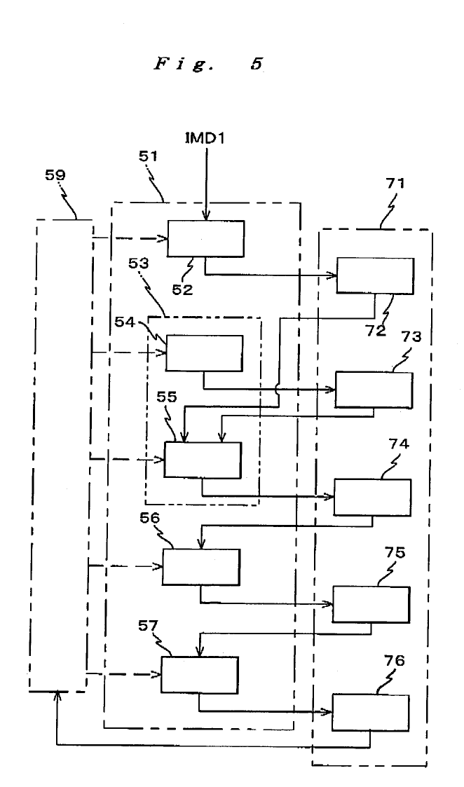

The wafer shape computing unit 51, as shown in FIG. 5, comprises (i) an image data collecting unit 52 for collecting image data IMD1 from the pre-alignment detection system RAS, (ii) a characteristic value calculating unit 53 for calculating a texture characteristic's values from data collected by the image data collecting unit 52, (iii) a boundary estimating unit 56 for estimating the boundary between the wafer's image and a background image by analyzing the distribution of the texture characteristic's values calculated by the characteristic value calculating unit 53, (iv) a parameter calculating unit 57 as a characteristic detecting unit for calculating the center position and radius of the wafer W as shape parameters thereof based on the estimating result of the boundary estimating unit 56. The characteristic value calculating unit 53 comprises a weight information computing unit 54 for obtaining weight for the datum of each pixel in a texture analysis window and a weighted characteristic value calculating unit 55 for calculating a texture characteristic's value of the image in the texture analysis window based on weight information and the datum of each pixel.

The wafer shape computation data store area 71 comprises an image data store area 72, a weight information store area 73, a texture characteristic value store area 74, an estimated boundary position store area 75, and a characteristic detecting result store area 76.

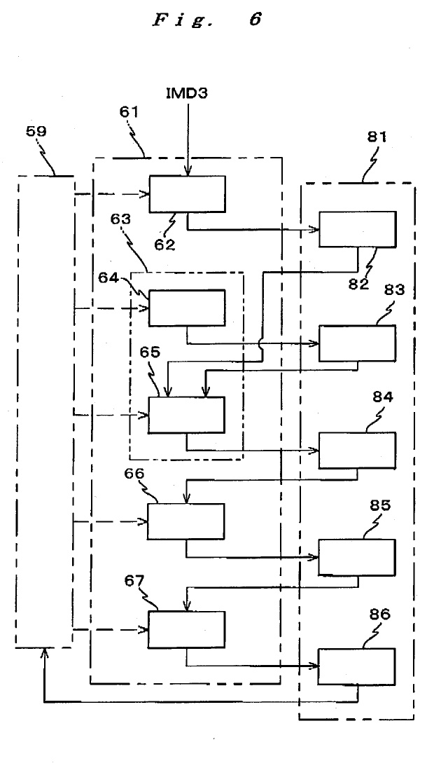

The shape of light source image computing unit 61, as shown in FIG. 6, has the same construction as the wafer shape computing unit 51, that is, comprises (i) an image data collecting unit 62 for collecting image data IMD3 from the light source image pick-up unit 30, (ii) a characteristic value calculating unit 63 for calculating a texture characteristic's values from data collected by the image data collecting unit 62, (iii) a boundary estimating unit 66 for estimating the boundary between the illuminant image and a background image by analyzing the distribution of the texture characteristic's values calculated by the characteristic value calculating unit 63, (iv) a parameter calculating unit 67 as a characteristic detecting unit for calculating the center position and radius of the illuminant image as shape parameters thereof based on the estimating result of the boundary estimating unit 66. The characteristic value calculating unit 63 comprises a weight information computing unit 64 for obtaining weight for the datum of each pixel in a texture analysis window and a weighted characteristic value calculating unit 65 for calculating a texture characteristic's value of the image in the texture analysis window based on weight information and the datum of each pixel.

The shape of light source image computation data store area 81 comprises an image data store area 82, a weight information store area 83, a texture characteristic value store area 84, an estimated boundary position store area 85, and a characteristic detecting result store area 86, which are similar to those of the wafer shape computation data store area 71.

It is noted that in FIGS. 4 to 6 a solid arrow indicates a data flow and a dashed arrow indicates a control flow. The operation of the various units of the main control system 20 will be described later.

Incidentally, while, in this embodiment, the main controller 50 comprises the various units as described above, the main control system 20 may be a computer system where the functions of the various units of the main controller 50 are implemented as program modules installed therein.

Furthermore, when the main control system 20 is a computer system, all program modules for accomplishing the functions, described later, of the various units of the main controller 50 need not be installed in advance therein. For example, the main control system 20 may be connected with a reader (not shown) to which a storage medium (not shown) is attachable and which can read program modules from the storage medium storing the program modules, and reads program modules necessary to accomplish functions from the storage medium loaded into the reader and executes the program modules.

Further, the main control system 20 may be constructed so as to read program modules from the storage media loaded into the reader and install them therein. Yet further, the main control system 20 may be constructed so as to install program modules sent through a communication network such as the Internet and necessary to accomplish functions therein.

Incidentally, as the storage medium, a magnetic medium (magnetic disk, magnetic tape, etc.), an electric medium (PROM, RAM with battery backup, EEPROM, etc.), a photo-magnetic medium (photo-magnetic disk, etc.), an electromagnetic medium (digital audio tape (DAT), etc.) and the like can be used.

Constructing, as described above, the main control system 20 and the stage control system 19 to be able to install program modules necessary to accomplish functions from storage media or through a communication network therein makes it easy to, later, change the program modules or replace them with a new version for improving capability.

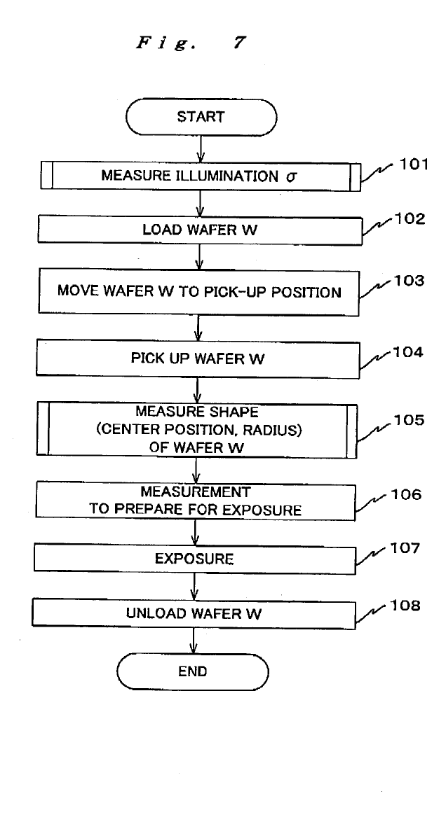

The exposure operation of the exposure apparatus 100 of this invention will be described below with reference to a flow chart of FIG. 7 and other figures as needed.

First, in subroutine 101 of FIG. 7, illumination σ is measured in detecting illumination characteristic information of the illumination system 10, which σ is defined as the ratio (D_{S}/D_{P}) of the diameter D_{S} of the illuminant image (in this embodiment, the secondary light source by the fly-eye lens) on the entrance pupil plane of the projection optical system PL to an effective diameter D_{P} of the entrance pupil that is the diameter of the aperture of the aperture stop 42 and known. The positions of the entrance pupil plane of the projection optical system PL and the light receiving face of the two-dimensional pick-up device 32 conjugate thereto are known. Therefore, the projection ratio β_{S} of the illuminant image on the light receiving face of the two-dimensional pick-up device 32 to the illuminant image on the entrance pupil plane of the projection optical system PL is also known. Thus the subroutine 101 obtains the illumination a from the result of picking up the illuminant image on the light receiving face of the two-dimensional pick-up device 32.

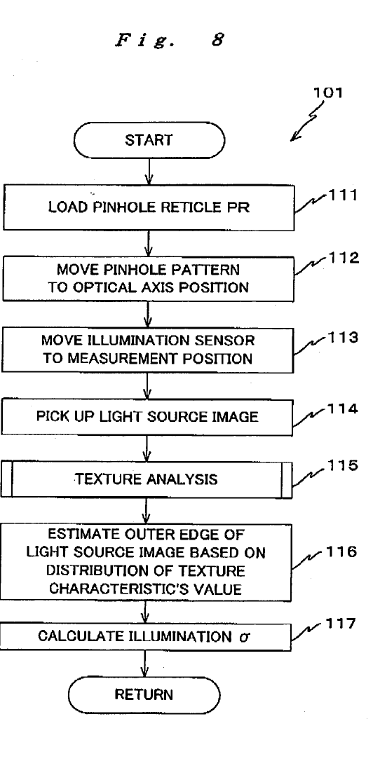

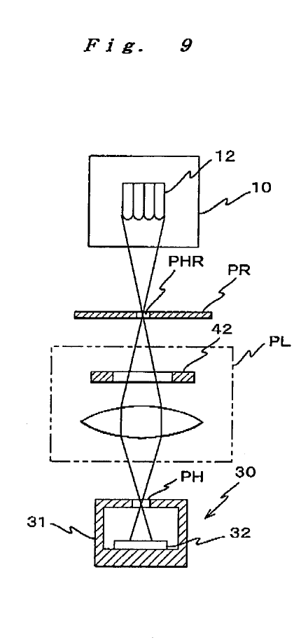

That is, in the subroutine 101, first in step 111 as shown in FIG. 8, a reticle loader (not shown) loads onto the reticle stage RST a pinhole reticle PR (see FIG. 9) for measurement on which a pinhole pattern PHR is formed in the center and shade is formed in the other part. The reason why the pinhole reticle PR is used is that in the subroutine 101 the telecentric degree of the projection optical system PL is measured together with the illumination σ.

Subsequently, in step 112 the main control system 20, specifically the controller 59 (see FIG. 4), moves the reticle stage RST and thus the pinhole reticle PR via the stage control system 19 and the reticle stage driving unit (not shown) such that the pinhole pattern is located in the optical axis's position planned in design.

Next, in step 113 the main control system 20, specifically the controller 59, moves the wafer stage WST and thus the light source image pick-up unit 30 (illumination σ sensor) via the stage control system 19 and the stage driving unit 21 such that the pinhole PH on the upper surface thereof is located in the optical axis's position planned in design.

This completes the arrangement of various elements for the light source image pick-up unit 30 picking up the illuminant image, which arrangement is shown schematically in FIG. 9.

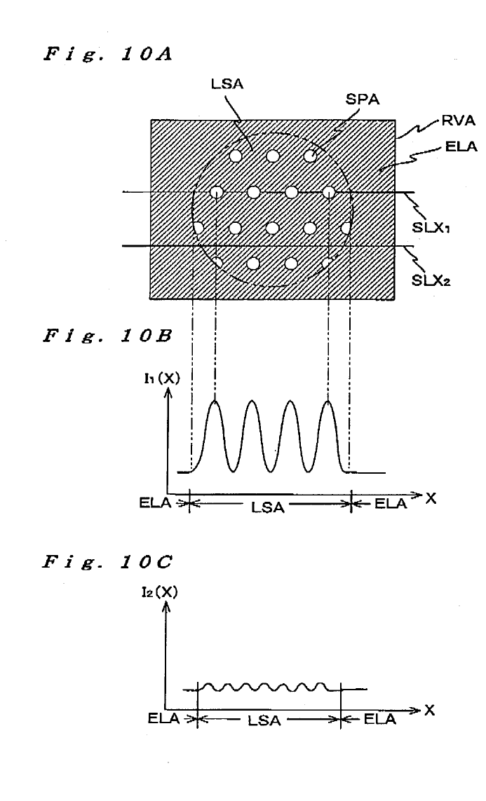

Referring back to FIG. 8, in step 114 the illumination system 10 emits illumination light, and the two-dimensional pick-up device 32 picks up the illuminant image formed on the light receiving face thereof. FIG. 10A shows an example of the picking-up result, where a illuminant image area LSA and an outside illuminant area ELA are present in a pick-up field RVA. And in the illuminant image area LSA a beehive-like arrangement of bright spots SPA is present. Meanwhile the outside illuminant area ELA is an almost uniformly dark area.

It is remarked that in the light source image area LSA, brightness varies not like a step from the bright spots SPA to the dark area. For example, FIG. 10B shows how the illuminance I₁(X) varies along an axis SLX₁ parallel to the X axis that is through the centers of spots as shown in FIG. 10A. Brightness represented by the illuminance I₁(X) is highest at the centers of the spots and decreases rapidly as X position goes away from the center. In the middle between the centers of spots next to each other, the brightness stands at the same level as in the outside illuminant area ELA. FIG. 10C shows how the illuminance I₂(X) varies along an axis SLX₂ parallel to the X axis and apart from the spots as shown in FIG. 10A. In the light source image area LSA, while brightness represented by the illuminance I₂(X) varies according to the distance between X position and the centers of spots, the amplitude of the variation is small and the brightness stands at almost the same level as in the outside illuminant area ELA.

As a result, if the center of a spot is close to the boundary between the illuminant image area LSA and the outside illuminant area ELA and noise is negligible, the boundary can be accurately estimated from the variation of the brightness according to position, which brightness is represented by data of pixels. Generally, however, it is difficult to accurately estimate the boundary from the variation of the brightness according to position.

The image data IMD3 obtained above is supplied to the main control system 20, where the image data collecting unit 62 receives and stores the image data IMD3 in the image data store area 82.

Referring back to FIG. 8, next a subroutine 115 performs image processing by texture analysis on the image data IMD3. First in step 121A of the subroutine 115, the weight information computing unit 64 of the characteristic value calculating unit 63 determines the shape of a texture analysis window. Here, a circle having a diameter close to the pitch of the spots planned in designed, which spots are in the light source image area LSA, is used as a texture analysis area for which texture analysis is performed for the purpose of performing texture analysis with isotropic sensitivity and no directivity. And a square circumscribed about the circle is used as the texture analysis window.

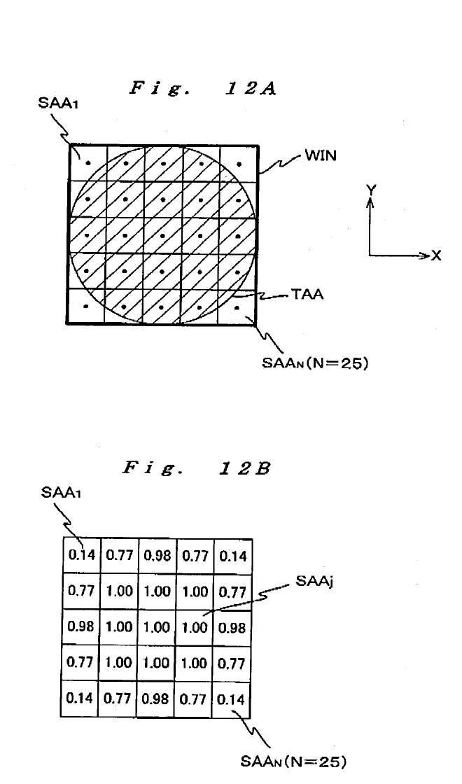

FIG. 12A shows examples of the texture analysis area TAA and the texture analysis window WIN, and the case where, when letting d indicate the dimension of pixels PX, the diameter D_{T} of the texture analysis area TAA is 5d. The description will be made below with reference to the texture analysis area TAA and the texture analysis window WIN in FIG. 12A.

Subsequently, the weight information computing unit 64 calculates weight information related to each pixel in the texture analysis window WIN. First, the weight information computing unit 64 divides the texture analysis window WIN into square areas SAAⱼ (j=1 through N (=25)) each corresponding to a pixel and subsequently calculates how much of each square area SAAⱼ is covered by the texture analysis area TAA and calculates the ratio ρⱼ of the area covered by the texture analysis area TAA to the whole area of each square area SAAⱼ, which ratio represents weight information related to a corresponding pixel. FIG. 12B shows weight information calculated, where a weight information value is attached to each square area SAAⱼ corresponding to a pixel.

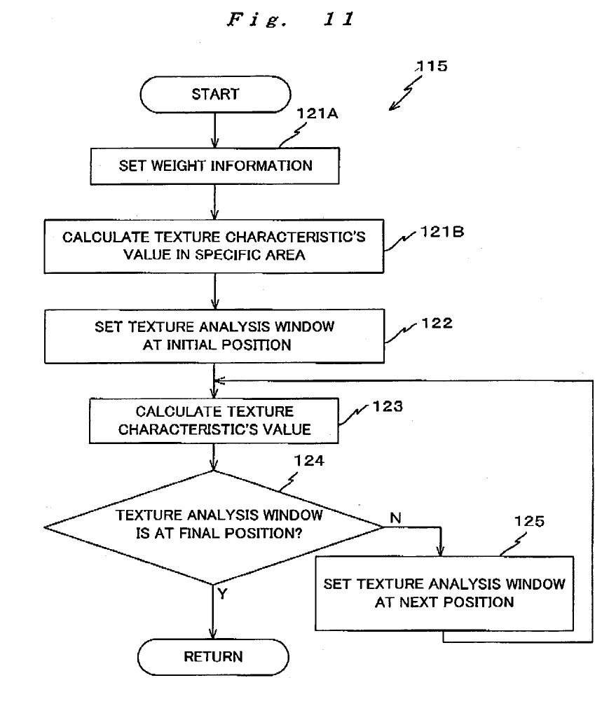

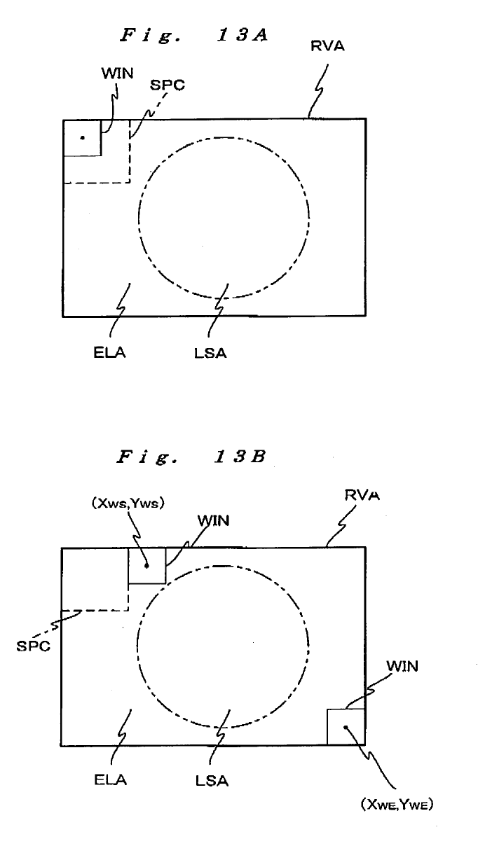

Referring back to FIG. 11, in step 121B, the weighted characteristic value calculating unit 65 of the characteristic value calculating unit 63 calculates a texture characteristic's values in a specific area SPC (see FIG. 13A) in the outside illuminant area ELA, which SPC area is in one of the four corner of the light receiving face of the two-dimensional pick-up device 32 and definitely in the outside illuminant area ELA. In this embodiment, the specific area SPC is located in the position shown in FIG. 13A.

In the calculation of a texture characteristic value, the weighted characteristic value calculating unit 65, first, reads image data, which is data from pixels in the light receiving face of the two-dimensional pick-up device 32, from the image data store area 82 and reconstructs the image that was on the light receiving face, and, while moving the texture analysis window WIN pixel by pixel within the specific area SPC of the reconstructed image, calculates, for each position thereof, variance of weighted data according to the weight information, which data are from pixels in the texture analysis window WIN, where the position of the texture analysis window WIN refers to the center of the texture analysis window WIN.

Here, the variance of the weighted data of the pixels in the texture analysis window WIN is calculated in the following manner.

Let (X, Y) and I_{wj}(X, Y) (j=1 through N) indicate the position of the texture analysis window WIN and each pixel's datum therein respectively. The weighted characteristic value calculating unit 65 calculates the mean μ(X, Y) of data of the pixels in the texture analysis window WIN given by the equation (1)

μ(X, Y)=(ΣI_{wj}(X, Y))/N (1)

where (ΣI_{wj}(X, Y)) represents the sum of data of the pixels in the texture analysis window WIN.

Subsequently, the weighted characteristic value calculating unit 65 calculates the variance V(X, Y) of the weighted data of the pixels in the texture analysis window WIN given by the equation (2)

V(X, Y)=(Σ{ρⱼ×(I_{wj}(X, Y)−μ(X, Y))²})/(N−1) (2)

Because the texture analysis window WIN is moved within the specific area SPC, the texture analysis window WIN stays in the outside illuminant area ELA where the data of pixels are almost the same, and the mean μ(X, Y) of data of the pixels in the texture analysis window WIN varies little according to the position of the texture analysis window WIN in the specific area SPC. Therefore, when letting μ_{E}′ indicate the mean μ(X, Y) given by the equation (1) for the initial position of the texture analysis window WIN in the specific area SPC, using μ_{E}′ instead of the mean μ(X, Y) in the equation (2) for all positions will reduce the total amount of calculation.

Next, the weighted characteristic value calculating unit 65 calculates the respective means over the specific area SPC of the above-obtained mean and variance, as the texture characteristic's value, of data of the pixels in the texture analysis window WIN.

Let μ_{E} and V_{E} indicate the respective means over the specific area SPC of the mean and variance of data of pixels in the texture analysis window WIN, where the value V_{E} represents the texture characteristic's value in the outside illuminant area ELA and is small because it is dark in the specific area SPC.

Incidentally, when using μ_{E}′ instead of the mean μ(X, Y) in the equation (2) for all positions, μ_{E}=μ_{E}′.

Referring back to FIG. 11, next in step 122, the texture analysis window WIN is set at an initial position (X_{ws}, Y_{ws}), as shown in FIG. 13B, for calculating texture characteristic values for outside the specific area SPC.

Subsequently, in step 123 the weighted characteristic value calculating unit 65 calculates variance V(X_{ws}, Y_{ws}) of data of pixels in the texture analysis window WIN in the initial position (X_{ws}, Y_{ws}) given by the equation (3)

V(X_{ws}, Y_{ws})=(Σ{ρⱼ×(I_{wj}(X_{ws}, Y_{ws})−μ_{E})²})/N (3)

The weighted characteristic value calculating unit 65 stores the calculated variance V(X_{ws}, Y_{ws}), as the texture characteristic's value, in the texture characteristic value store area 84.

Next, the weight information computing unit 64, in step 124, checks whether or not the texture analysis window WIN is in a final position (X_{WE}, Y_{WE}) as shown in FIG. 13B. At this stage because the texture analysis window WIN is in the initial position (X_{ws}, Y_{ws}), the answer is NO and the process proceeds to step 125.

In step 125 the weighted characteristic value calculating unit 65 moves the texture analysis window WIN by the pitch of pixels to a next position, and the process proceeds to step 123.

Until the answer in step 124 is YES, the weighted characteristic value calculating unit 65 repeats the steps 123 through 125, where for each position of the texture analysis window WIN, variance V(X, Y) is calculated and stored in the texture characteristic value store area 84. When the answer in step 124 is YES, the subroutine 115 ends and the process proceeds to step 116.

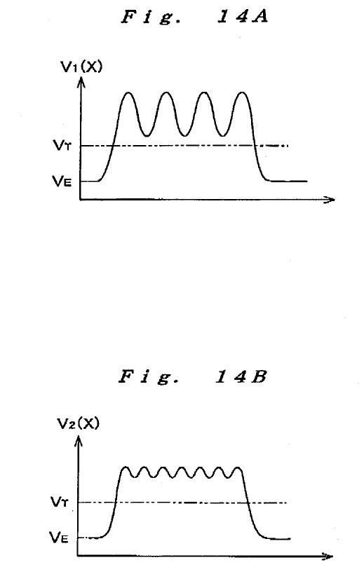

In step 116 the boundary estimating unit 66 reads from the texture characteristic value store area 84 the variances V(X, Y), as the texture characteristic's values, ones on the axis SLX₁ in FIG. 10A of which form a distribution V₁(X) as shown in FIG. 14A and ones on the axis SLX₂ in FIG. 10B of which form a distribution V₂(X) as shown in FIG. 14B. Both of the distributions V₁(X) and V₂(X) take on about V_{E} in the outside illuminant area ELA and values clearly greater than the value V_{E}, while these values vary, in the light source image area LSA. On the boundary between the outside illuminant area ELA and the illuminant image area LSA the values of the distributions V₁(X) and V₂(X) vary sharply between the value V_{E} and values in the light source image area LSA. Such variation of the value of the variance V(X, Y) occurs at any point on the boundary.

Using such characteristic of the variance V(X, Y) on the boundary between the outside illuminant area ELA and the light source image area LSA, the boundary estimating unit 66 estimates the boundary, i.e. the outer edge of the illuminant image, to be at a position where the variance takes on a value V_{T} that is meaningfully greater than the value V_{E} and smaller than the mean of the variance in the light source image area LSA. Here, the value V_{T} may be the middle between the value V_{E} and the mean of the variance in the light source image area LSA.

Estimating the boundary between the outside illuminant area ELA and the illuminant image area LSA in the above manner results in the boundary being a closed curve. It is noted that in this embodiment because the variances V(X, Y) where data of pixels in the texture analysis window WIN are weighted according to coverage by the circular area TAA are calculated, the accuracy in estimating the boundary is the same in any position on the boundary.

The boundary estimating unit 66 estimates in the above manner the boundary between the outside illuminant area ELA and the illuminant image area LSA to be a closed curve and stores position data of the estimated boundary in the estimated boundary position store area 85.

Referring back to FIG. 8, in step 117 the parameter calculating unit 67 reads the position data of the estimated boundary from the estimated boundary position store area 85 and calculates the center position O_{S} and radius R_{S} of the illuminant image area LSA based on the position data of the estimated boundary by use of a statistical technique such as the least-squares method. The telecentric degree of the projection optical system PL is obtained from the center position O_{S} calculated, and the illumination σ given by the equation (4) is calculated from the radius R_{S} using the pupil plane diameter D_{P} and the projection ratio β_{S} of the illuminant image,

σ=(2×R_{S})/(β_{S}×D_{P}) (4)

The parameter calculating unit 67 stores the telecentric degree and the illumination a calculated in the characteristic detecting result store area 86, and the controller 59 reads the telecentric degree and the illumination σ from the characteristic detecting result store area 86 and checks whether or not these are in respective permissible ranges. If the answer is NO, the illumination system 10 or the projection optical system PL is adjusted, and the telecentric degree and the illumination a are measured again. In this way the subroutine 101 ends, and the process returns to the main routine in FIG. 7.

After the completion of the above-described measurement (and, if needed, adjustment) of the telecentric degree and the illumination σ of the projection optical system PL, the exposure apparatus 100 of this embodiment performs exposure operation.

In the exposure operation, first in step 102, the reticle loader (not shown) loads a reticle having a given pattern formed thereon onto the reticle stage RST, and the wafer loader (not shown) loads a wafer W onto the substrate table 18.

Next in step 103, the main control system 20, specifically the controller 59 (see FIG. 4), moves the substrate table 18 with the wafer W via the stage control system 19 and the wafer stage driving unit 21 to a pickup position where the pre-alignment sensors 40A, 40B, 40C pick up the image and roughly positions it such that the notch N of the wafer W is underneath the pre-alignment sensor 40A and the periphery of the wafer W is underneath the pre-alignment sensors 40B, 40C.

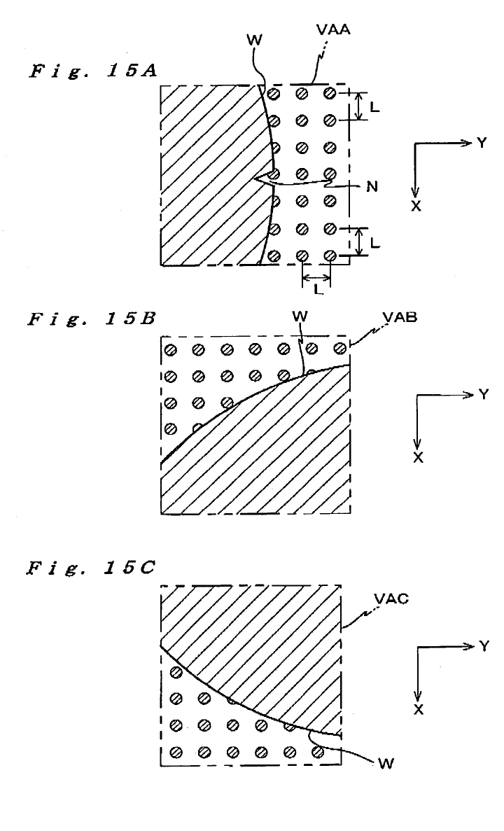

Subsequently, in step 104 the pre-alignment sensors 40A, 40B, 40C pick up the image of the wafer W's periphery. FIGS. 15A, 15B, and 15C show the examples of the picking-up results, that is, the wafer W's images in pick-up field VAA of the pre-alignment sensor 40A, in pick-up field VAB of the pre-alignment sensor 40B, and in pick-up field VAC of the pre-alignment sensor 40C respectively.

As shown in FIGS. 15A through 15C, while the images of the wafer W are uniformly dark, outside the wafer W there is a matrix arrangement of dark spot images that are arranged a distance L apart from each other. The dark spot images are the images of patterns formed beforehand on the substrate table 18 that form a pattern. The pattern is not limited to the one shown in FIGS. 15A through 15C, and any pattern can be used for which the value of the texture characteristic (e.g. variance) is constant. That is, the pattern may be plain. Here, it is assumed that the brightness of the image of the wafer W is almost the same as that of the dark spot images outside the wafer W. Therefore, the outer edge of the wafer W's image cannot be accurately estimated based only on the distribution of the brightness. Data of the wafer W's images is supplied as image data IMD1 to the main control system 20. The image data collecting unit 52 of the main control system 20 receives and stores the image data IMD1 in the image data store area 72.

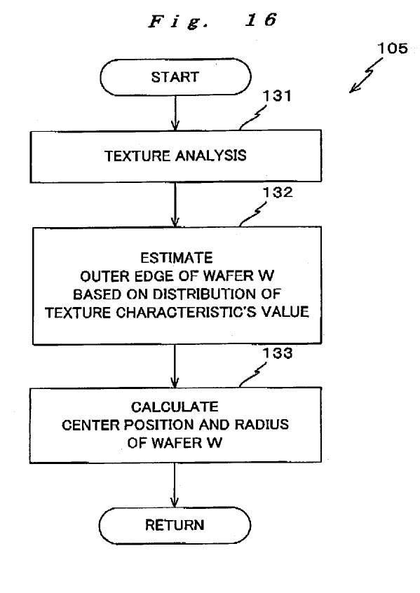

Referring back to FIG. 7, next in subroutine 105 the center position Q_{W} and radius R_{W} as shape parameters of the wafer W are measured. First in step 131 of subroutine 105 as shown in FIG. 16, the same texture analysis as in the above subroutine 115 is performed except that for each position of the texture analysis window WIN the mean of data of pixels therein is used in the calculation of variance V(X, Y).

That is, in step 131 the weight information computing unit 54 of the characteristic value calculating unit 53 determines the shapes of the texture analysis area and the texture analysis window, which are the same as in FIG. 12A in the below description.

Next, the weight information computing unit 54 obtains weight information as shown in FIG. 12B in the same way as in subroutine 115, and the weighted characteristic value calculating unit 55, first, reads the image data of the wafer W from the image data store area 72 and reconstructs the image picked up.

Next, the weighted characteristic value calculating unit 55, while moving the texture analysis window WIN pixel by pixel within the specific area SPC of the reconstructed image, calculates, for each position (X, Y) thereof, variance V(X, Y) as the texture characteristic's value of data I_{wj}(X, Y) from pixels in the texture analysis window WIN. In the calculation of the variance V(X, Y), first the weighted characteristic value calculating unit 55 calculates the mean μ(X, Y) of data of the pixels in the texture analysis window WIN given by the equation (5)

μ(X, Y)=(ΣI_{wj}(X, Y))/N (5)

And the variance V(X, Y) of the data of the pixels in the texture analysis window WIN is calculated that is given by the equation (6)

V(X, Y)=(Σ{ρⱼ×(I_{wj}(X, Y)−μ(X, Y))²})/(N−1) (6)

Subsequently, the weighted characteristic value calculating unit 55 stores the variances V(X, Y) for from the initial position through the final position of the texture analysis window WIN in the texture characteristic value store area 74. This ends the process in step 131.

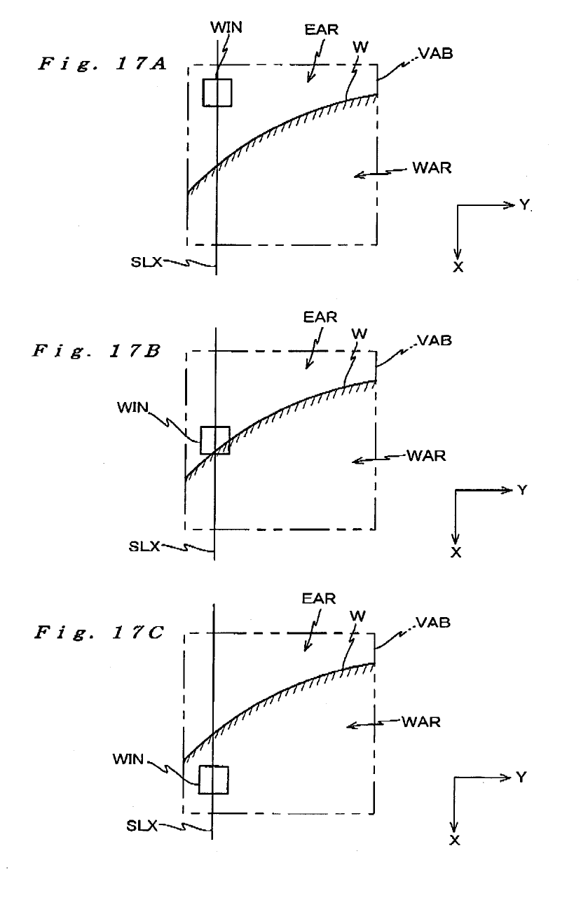

Next, in step 132 the boundary estimating unit 56 reads the variances V(X, Y) as the texture characteristic's values from the texture characteristic value store area 74. When moving the texture analysis window WIN, for example, along an axis SLX parallel to the X axis as shown in FIGS. 17A through 17C, the value of the variance V(X, Y), as a function of X and Y, varies in the following way. When the texture analysis window WIN is present in an outside wafer image area EAR as shown in FIG. 17A, because the outside wafer image area EAR is almost uniformly bright, the variance V(X, Y) takes on a small value, and, when the texture analysis window WIN is present on the boundary between the outside wafer image area EAR and an inside wafer image area WAR as shown in FIG. 17B, because data of some pixels are large in value and others' data are small, the variance V(X, Y) takes on a large value, and, when the texture analysis window WIN is present in the inside wafer image area WAR as shown in FIG. 17C, because the outside wafer image area EAR is almost uniformly dark, the variance V(X, Y) takes on a small value.

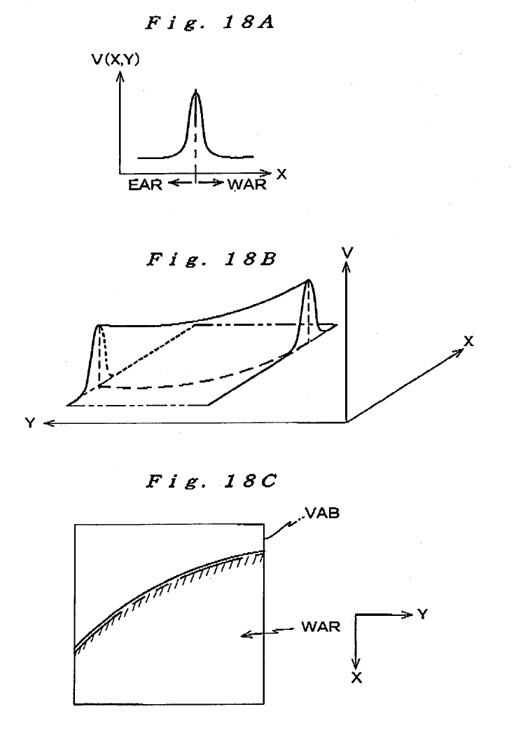

FIG. 1A shows a graph representing the variation of the variance V(X, Y) shown in FIGS. 17A through 17C. In FIG. 18A, when the texture analysis window WIN is present around the boundary between the outside wafer image area EAR and the inside wafer image area WAR, the variance V(X, Y) takes on a larger value than when the texture analysis window WIN is in the outside wafer image area EAR or the inside wafer image area WAR, and when the texture analysis window WIN is present just on the boundary between the outside wafer image area EAR and the inside wafer image area WAR, the variance V(X, Y) takes on a local maximum. Such characteristic of the variation is the case with any position on the boundary. FIG. 18B shows the two-dimensional variation of the variance V(X, Y).

The boundary estimating unit 56 estimates the boundary between the outside wafer image area EAR and the inside wafer image area WAR to be in position where the variance V(X, Y) takes on a local maximum in light of the characteristic of the variance V(X, Y)'s variation.

Estimation of the boundary between the outside wafer image area EAR and the inside wafer image area WAR in the foregoing manner results in an estimated outer edge of the wafer indicated by a solid line in FIG. 18C with respect to the actual outer edge of the wafer indicated by a two-dot-dashed line. The boundary estimating unit 56 stores the estimated boundary position data in the estimated boundary position store area 75. It is noted that in this embodiment because the variances V(X, Y) where data of pixels in the texture analysis window WIN are weighted according to coverage by the circular area TAA are calculated, the accuracy in estimating the boundary is the same in any position on the boundary.

Referring back to FIG. 16, next in step 133 the parameter calculating unit 67 calculates the center position Q_{W} and radius R_{W} of the inside wafer image area WAR based on the position data of the estimated boundary by use of a statistical technique such as the least-squares method, and stores the obtained center position Q_{W} and radius R_{W} in characteristic detecting result store area 76.

Subsequently, the controller 59 detects the notch N's position of the wafer based on the image data of the wafer's periphery (specifically, image data from pick-up field VAA (see FIG. 15A)) stored in the wafer shape computation data store area 71, so that the rotation angle of the wafer W about the Z axis is detected, and based on the detected rotation angle of the wafer W about the Z axis, as needed, rotates the water holder 25 via the stage control system 19 and the wafer stage driving unit 21.

This ends the process in subroutine 105, and the process returns to the main routine in FIG. 7.

Next in step 106, the controller 59 performs preparation such as reticle alignment using a reference mark plate (not shown) provided on the substrate table 18 and measurement of base line amount of the alignment detection system AS. Further, when exposure for a second or later layer is performed, in order to form a sub-circuit pattern with good overlay accuracy with respect to an already formed sub-pattern, the positional relation between a reference coordinate system for specifying the movement of the wafer stage WST with the wafer W and an arrangement coordinate system for arrangement of circuit patterns, chip areas, on the wafer W is accurately measured by the alignment detection system AS based on the above-mentioned result of measuring the wafer W's shape.

Next, in step 107 exposure for the first layer is performed. In the exposure operation the substrate table 18 with the wafer W is moved so that a first shot area on the wafer W is positioned at a scan start position for exposure. The main control system 20 controls such movement via the stage control system 19 and the wafer stage driving unit 21 based on the above-mentioned result of measuring the wafer W's shape read from the estimated boundary position store area 75, position information (or speed information) from the wafer interferometer 28, and the like, and, if it is the second or later layer, the result of detecting the positional relation between the reference coordinate system and the arrangement coordinate system as well. At the same time the main control system 20 moves the reticle stage RST so that the reticle R is positioned at a scan start position for reticles, via the stage control system 19 and a reticle stage driving unit (not shown).

Next, the stage control system 19, according to instructions from the main control system 20, performs scan exposure while adjusting the position of the wafer W surface and moving relatively the reticle R and wafer W based on the Z position information of the wafer w from the multi focus position detection system, the X-Y position information of the reticle R from the reticle interferometer 16, and the X-Y position information of the wafer W from the wafer interferometer 28, via the reticle stage driving unit (not shown) and via the wafer stage driving unit 21. After the completion of exposure of the first shot area, the substrate table 18 is moved so that a next shot area is positioned at the scan start position for exposure, and at the same time the reticle stage RST is moved so that the reticle R is positioned at the scan start position for reticles. The scan exposure on the shot area is performed in the same way as on the first shot area. After that, the scan exposure is repeated until all shot areas have been exposed.

In step 108 an unloader (not shown) unloads the exposed wafer W from the substrate table 18, by which the exposure of the wafer W is completed.

It is noted that in the case of the scan exposure for the first layer, the position of the wafer W is corrected based on the above-mentioned result of measuring the wafer W's shape, so that the deviation and rotation θ of the arrangement coordinate system from its position and to its origin planned in design becomes almost zero, but that, when the deviation of the center position Qw and the rotation θ are small, the correction of the position based on the above-mentioned result of measuring the wafer W's shape may be omitted. Moreover, in the case of the scan exposure for the second or later layer, in synchronous movement of the reticle stage RST and the wafer stage WST the above-mentioned result of measuring the wafer W's shape is not needed while, in fine alignment before the scan exposure, it is used to move the wafer stage WST.

Further, before the scan exposure for the first layer and before fine alignment for the second or later layer, the wafer holder 25 with the wafer W may be rotated based on the above-mentioned result of measuring the wafer W's shape, in which case, upon the scan exposure for the first layer and upon fine alignment for the second or later layer, the above-mentioned result, i.e. the rotation θ, is not needed. Alternatively by, initially, finely adjusting the position of the wafer W on the wafer holder 25 based on the center position Q_{W} as well as the rotation θ, the necessity to use the center position Q_{W} in later operation can be eliminated.

As described above, according to this embodiment because the boundary between the illuminant image area LSA and the outside illuminant area ELA, which each have a intrinsic pattern and which boundary cannot be estimated to be a curve only from brightness distribution in image data, is estimated by texture analysis, it can be estimated to be a curve very close to the actual boundary. Therefore, the telecentric degree and the illumination σ of the projection optical system PL can be accurately measured.

Because the boundary between the inside wafer image area WAR and the outside wafer image area EAR, which each have a intrinsic pattern and which boundary cannot be estimated to be a curve only from brightness distribution in image data, is estimated by texture analysis, it can be estimated to be a curve very close to the actual boundary. Therefore, the position of the wafer W can be accurately detected.

In this embodiment the calculation of the texture characteristic value for the image in the square texture analysis window WIN, circumscribed about the circular texture analysis area TAA, is performed where datum from each pixel in the texture analysis window WIN is weighted according to the ratio of the area covered by the texture analysis area TAA to the whole area of a corresponding one of square areas SAA that the texture analysis window WIN is divided into. As a result, the texture characteristic value, i.e., the variance V(X, Y) is calculated where the weights are the same for pixels whose distances from the center of the texture analysis window WIN are the same. The obtained texture characteristic value V(X, Y) has isotropic sensitivity and no directivity. Therefore, performing texture analysis on the texture characteristic value V(X, Y) results in texture analysis with isotropic sensitivity. Thus the shape of the illuminant image on the pupil plane of the projection optical system PL and the wafer W can be accurately obtained with high tolerance to noise, so that the illumination σ of the projection optical system PL and the position of the wafer W can be accurately detected.

According to the exposure apparatus of this embodiment, based on the result of very accurately measuring the illumination a of the projection optical system PL and the position of the wafer W by use of the above detection method, a pattern is transferred onto shot areas. Therefore, the pattern can be accurately transferred onto shot areas.

Although, in texture analysis of the above embodiment for measuring the illumination σ, the variances are calculated using the mean μ_{E} of data of pixels in the texture analysis window WIN when it is in the outside illuminant area ELA, the variances, as texture characteristic values, may be calculated in the same way as in texture analysis for measuring the wafer W's shape.

While in texture analysis for measuring the wafer W's shape, the variance of data of pixels in the texture analysis window WIN is calculated as a texture characteristic value, the variance may, in the same way as in texture analysis for the illumination σ, be calculated as a texture characteristic value with substituting the mean of data of pixels in the texture analysis window WIN when it is anywhere in the inside wafer image area WAR or the outside wafer image area EAR into the equation (6).

While in the above embodiment upon texture analysis for measuring the wafer W's shape, the size of the texture analysis window WIN is determined from the known period of the intrinsic pattern in the outside wafer image area EAR, if the intrinsic pattern is unknown, by moving texture analysis windows having different sizes within a specific area that is supposed to be in the outside wafer image area EAR and calculating texture characteristic values, a window for which texture characteristic values are almost the same may be found to use it for texture analysis.

Further, if the intrinsic pattern in the outside wafer image area EAR is unknown, by examining the variation of the texture characteristic's value as a function of position, while moving a texture analysis window WIN within the specific area, and identifying an image area having different variation from it, the boundary may be estimated.

If a given regular circuit pattern or plain one has been formed on the wafer W, by moving texture analysis windows having different sizes in the inside wafer image area WAR and calculating texture characteristic values, a window for which texture characteristic values are almost the same may be found to use it for texture analysis.

Incidentally, the size of the texture analysis window WIN only has to be large enough to reflect the characteristic of the intrinsic pattern and smaller than that of the wafer image or the illuminant image.

Further, while in this embodiment the texture characteristic value is the variance of data of pixels in the texture analysis window WIN, the mean of the data of pixels in the texture analysis window WIN may be used as the texture characteristic value.

While in this embodiment, the texture analysis window WIN is a square having a dimension of five times that of a pixel, it may have a dimension according to the pattern of an image to be analyzed.

Further, while in this embodiment the texture characteristic value is the variance of data of pixels in the texture analysis window WIN, the mean of the data of pixels in the texture analysis window WIN may be used as the texture characteristic value, in which case, in the calculation of the mean, datum of each pixel is weighted.

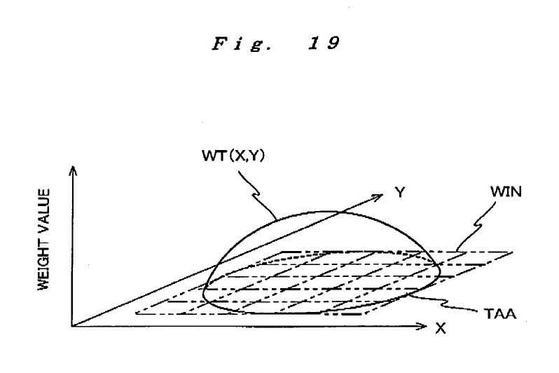

While intrinsic weight information used as the weight information in this embodiment refers to the ratio of the area covered by the texture analysis area TAA to the whole area of a corresponding one of square areas SAA that the texture analysis window WIN, circumscribed about the circular texture analysis area TAA, is divided into, weight information WT(X, Y) may be used that is represented by, e.g., a rotationally symmetric surface whose summit is in the center of the texture analysis area TAA, shown in FIG. 19.

Moreover, while in this embodiment the measuring method of this invention is applied to measurement of the illumination σ and measurement of the wafer W's shape, it can be applied to measurement along with extraction of an outline from an image.

Moreover, while in this embodiment the shape of an object whose image is to be measured is a circle, it may be an ellipse, square, etc.

<<A Second Embodiment>>

Next, the exposure apparatus of a second embodiment will be described. This embodiment differs from the exposure apparatus of the first embodiment in the construction of the pre-alignment detection system and the construction and operation of the wafer shape computing unit 51. The description in the below will focus mainly on the differences. The same numerals or symbols as in the first embodiment indicate elements which are the same as or equivalent to those in the first embodiment, and no description thereof will be provided.

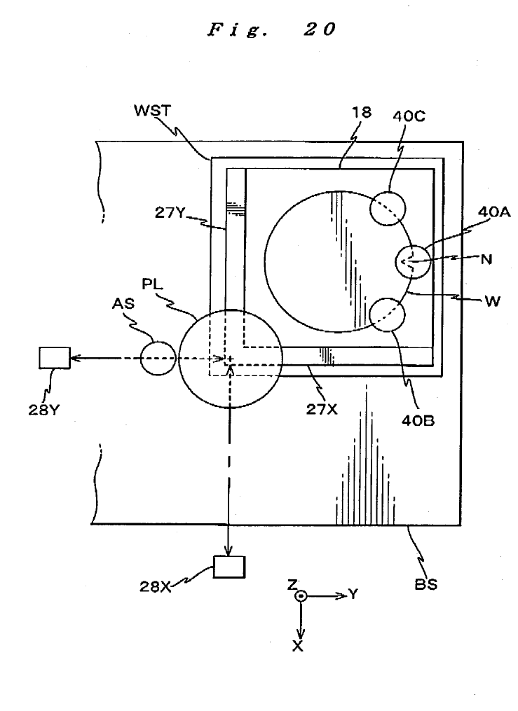

The pre-alignment detection system RAS of this embodiment comprises three pre-alignment sensors 40A, 40B, 40C which are, as shown in FIG. 20, arranged such that the sensor 40A is located above the notch N of a wafer W, and the sensors 40B, 40C are angular distances of −45 and +45 degrees respectively apart from the sensor 40A along the water W's outer edge, which notch is directed in the +Y direction. It is remarked that the CCD camera 40A is, as in the first embodiment, located in a position where it can pick up the image of the notch N of the wafer W held on the wafer holder 25.

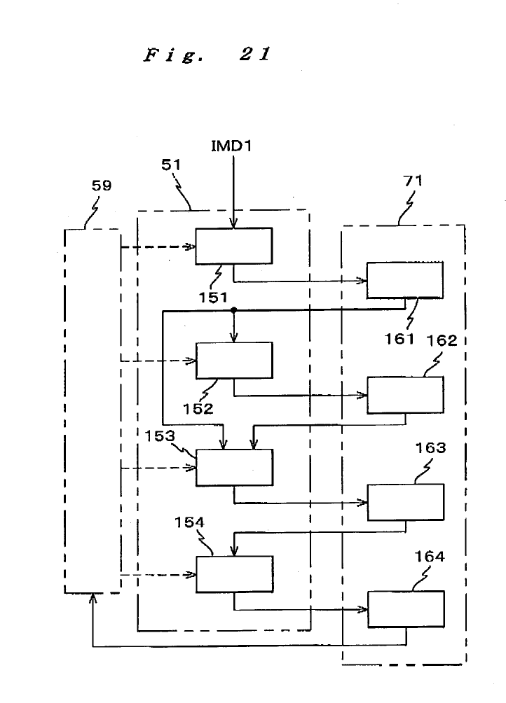

The wafer shape computing unit 51 of this embodiment, as shown in FIG. 21, comprises (a) an image data collecting unit 151 for collecting image data IMD1 from the pre-alignment detection system RAS, (b) a threshold value calculating unit 152 for calculating a threshold value for discriminating between the wafer image area and the background area based on data collected by the image data collecting unit 151, (c) a edge position estimating unit 153 for estimating the outer edge of the wafer W to obtain position information thereof based on the data collected by the image data collecting unit 151 and the threshold value calculated by the threshold value calculating unit 152, (d) a wafer position information estimating unit 154 for estimating the center position and rotation of the wafer W based on the estimating result of the edge position estimating unit 153.

A wafer shape computation data store area 71 of this embodiment comprises an image data store area 161, a threshold value store area 162, an outer edge position store area 163, and a wafer position information store area 164. It is noted that in FIG. 21 a solid arrow indicates a data flow and a dashed arrow indicates a control flow. The operation of the various units of the main control system 20 will be described later.

While, in this embodiment, the wafer shape computing unit 51 comprises the various units as described above, the main control system 20 may be a computer system where the functions of the various units of the wafer shape computing unit 51 are implemented as program modules installed therein, as in the first embodiment.

The exposure operation of the exposure apparatus 100 of this embodiment will be described in the following, which operation differs from that of the first embodiment only in the process of the subroutine 105 in FIG. 7, i.e., the process for calculating the center position, radius, etc., of the wafer W.

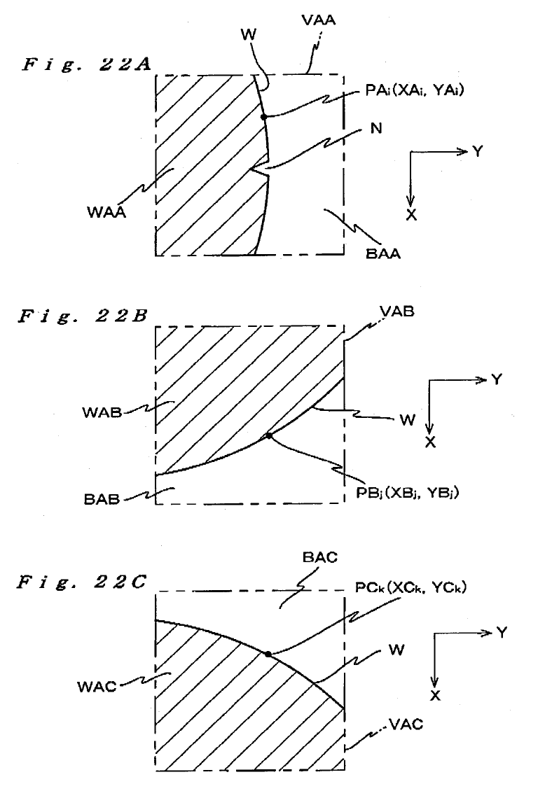

The exposure apparatus 100 of this embodiment measures the illumination a in subroutine 101 of FIG. 7, and, in steps 102 through 104, a reticle and a wafer W are loaded onto the reticle stage RST and the substrate table 18 respectively, and after the wafer W is moved to a pick-up position, the pre-alignment sensors 40A, 40B, 40C pick up the images of the wafer W's periphery, of which examples are shown in FIGS. 22A through 22C.

FIG. 22A shows the wafer W's image in pick-up field VAA of the pre-alignment sensor 40A, where there are two areas, wafer image area WAA and background area BAA, in pick-up field VAA. In this embodiment it is assumed that brightness in pixels of the wafer image area WAA is lower than that of the background area BAA, which is almost uniform.

FIG. 22B shows the wafer W's image in pick-up field VAB of the pre-alignment sensor 40B, where there are two areas, wafer image area WAB and background area BAB, in pick-up field VAB. In this embodiment it is assumed that, as in pick-up field VAA, brightness in pixels of the wafer image area WAB is lower than that of the background area BAB, which is almost uniform.

FIG. 22C shows the wafer W's image in pick-up field VAC of the pre-alignment sensor 40C, where there are two areas, wafer image area WAC and background area BAC, in pick-up field VAC. In this embodiment it is assumed that, as in pick-up field VAA, brightness in pixels of the wafer image area WAC is lower than that of the background area BAC, which is almost uniform.

Data of the wafer W's images is supplied as image data IMD1 to the main control system 20. The image data collecting unit 151 of the main control system 20 receives and stores the image data IMD1 in the image data store area 161.

Referring back to FIG. 7, next in subroutine 105 the shape parameters of the wafer W are measured based on the images of the wafer W's periphery stored in the image data store area 161 to calculate the center position and rotation about the Z axis of the wafer W.

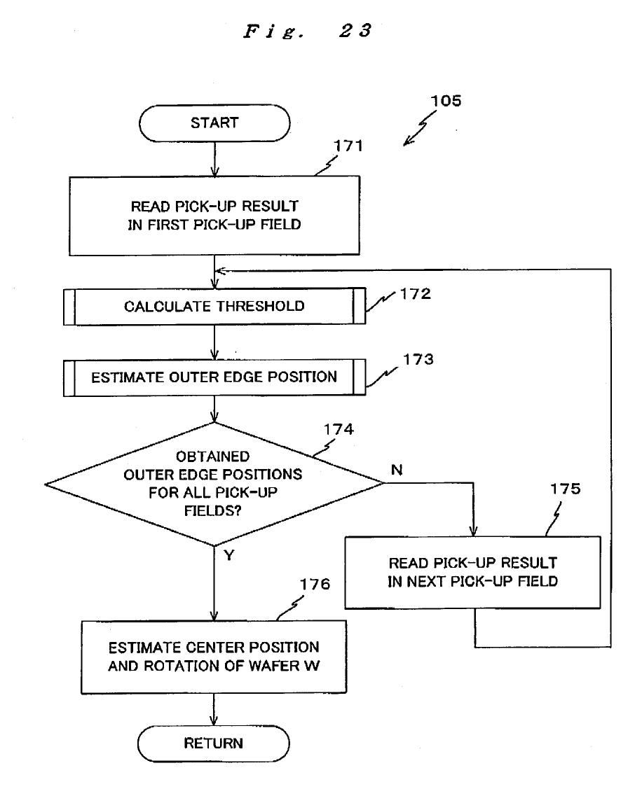

First in step 171 of subroutine 105 in FIG. 23, the threshold value calculating unit 152 reads the image data of a first pick-up field, herein pick-up field VAA, from the image data store area 161.

Next in subroutine 172 the threshold value calculating unit 152 calculates a threshold value (hereinafter called “threshold JT_{A}”) for discriminating between the wafer image area WAA and the background area WBB in the image data of pick-up field VAA by use of a least-entropy method.

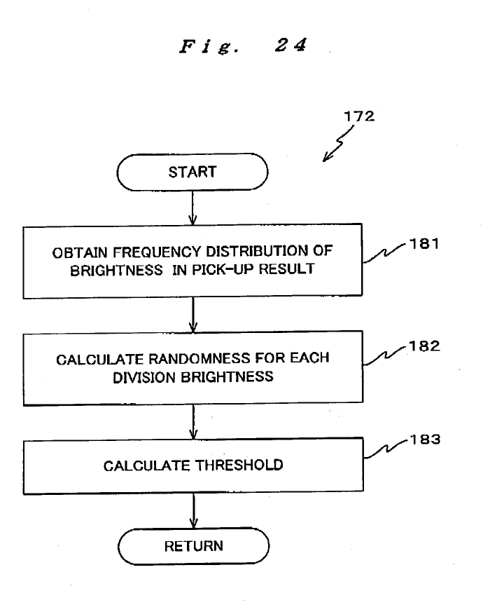

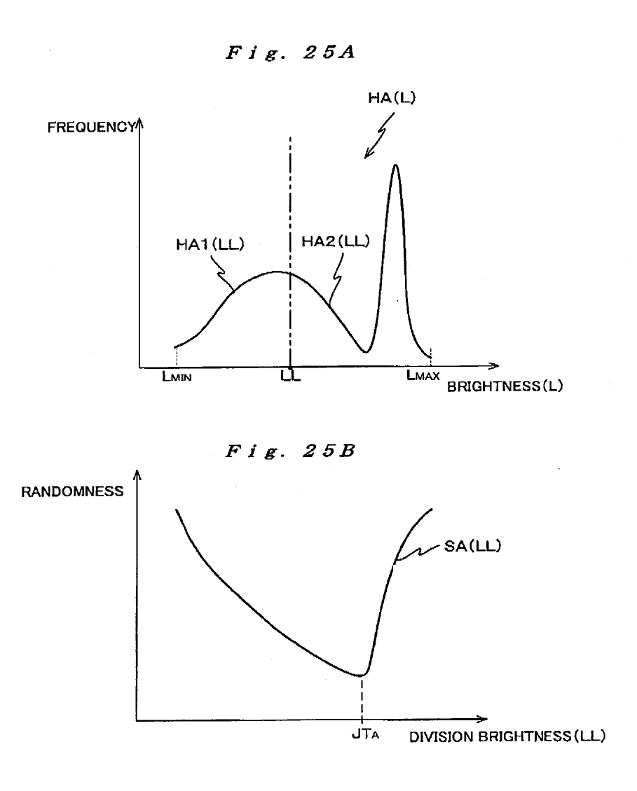

Here, as shown in FIG. 24, first in step 181, the threshold value calculating unit 152 obtains frequency distribution of brightness in pixels in the image data of pick-up field VAA. FIG. 25A shows an example of frequency distribution or histogram HA(L), where L denotes brightness. Let L_{MIN}, L_{MAX}, and NT denote the minimum, the maximum, and the total frequency, i.e. the number of pixels, of the frequency distribution HA(L) respectively.

Next, in step 182 while changing division brightness LL from L_{MIN} through (L_{MAX}−1) by units, herein unit=1, the threshold value calculating unit 152 calculates randomness SA1(LL), given by the equation (7), in part HA1(LL) of the frequency distribution HA(L) whose brightness is not higher than division brightness LL, the total frequency of the part being denoted by N1,

SA1(LL)=(N1/NT)×[Ln((2π)^{1/2}×σ1(LL))+(1/2)] (7)

where Ln(X) and σ1(LL) denote natural logarithm of X and variance of brightness in HA1(LL) respectively.

Further, the threshold value calculating unit 152 calculates randomness SA2(LL), given by the equation (8), in part HA2(LL) of the frequency distribution HA(L) whose brightness is higher than division brightness LL, the total frequency of the part being denoted by N2(=NT−N1),

SA2(LL)=(N2/NT)×[Ln((2π)^{1/2}×σ2(LL))+(1/2)] (8)

where σ2(LL) denotes variance of brightness in HA2(LL).

And the threshold value calculating unit 152 calculates total randomness SA(LL) for division brightness LL given by the equation (9)

SA(LL)=SA1(LL)+SA2(LL) (9)

FIG. 25B shows how the total randomness SA(LL) the varies according to division brightness LL.

Next, in step 183 the threshold value calculating unit 152 obtains threshold value JT_{A}, which is the brightness where the total randomness SA(LL) is minimal, from the variation of the total randomness SA(LL) according to division brightness LL.

The threshold value calculating unit 152 stores the obtained threshold value JT_{A} in the threshold value store area 162. The calculation of the threshold value JT_{A} in pick-up field VAA ends, and the process proceeds to subroutine 173 in FIG. 23.

In subroutine 173 the edge position estimating unit 153 calculates an estimated position of the outer edge of the wafer W in pick-up field VAA.

Next, the principle of estimating a position of the outer edge of a wafer W will be briefly described.

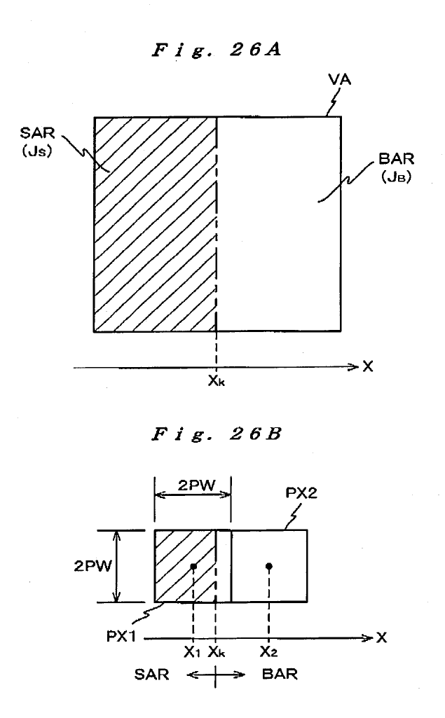

As a premise, it is assumed that the boundary between object area SAR and background area BAR in pick-up field VA, i.e. the outer edge of the object in pick-up field VA, is a line (X=Xₖ) parallel to the Y axis as shown in FIG. 26A, and that around the outer edge of the object the brightness in pixels in object area SAR stands uniformly at J_{S} except for pixels on the outer edge while the brightness in pixels in background area BAR stands uniformly at J_{B} except for pixels on the outer edge.

Consider pixel PX1 on the outer edge and pixel PX2 adjacent thereto in the +X direction. Let X₁ and X₂ indicate the center positions in the X direction of pixels PX1 and PX2 respectively, the pixels PX1 and PX2 each being a square having a dimension of 2×PW.

When the X position Xₖ of the outer edge varies from the edge in the −X direction (X=X₁−PW) of pixel PX1 through the edge in the +X direction (X=X₁+PW) thereof, brightness J1(Xₖ) of pixel PX1 that is a function of the X position Xₖ of the outer edge is given by the equation (10)

J1(Xₖ)=(J_{S}×(Xₖ−X₁+PW)+J_{B}×(−Xₖ+X₁+PW))/(2×PW) (10)

Meanwhile, brightness J2(Xₖ) of pixel PX2 does not vary and is given by the equation (11)

J2(Xₖ)=J_{B} (11)

Next, when the X position Xₖ of the outer edge varies from the edge in the +X direction (X=X₁+PW) of pixel PX1, i.e. the edge in the −X direction (X=X₂−PW) of pixel PX2, through the edge in the +X direction (X=X₂+PW) of pixel PX2, brightness J1(Xₖ) of pixel PX1 does not vary and is given by the equation (12)

J1(Xₖ)=J_{S} (11)

Meanwhile, brightness J2(Xₖ) of pixel PX2 that is a function of the X position Xₖ of the outer edge is given by the equation (13)

J2(Xₖ)=(J_{S}×(Xₖ−X₂+PW)+J_{B}×(−Xₖ+X₂+PW))/(2×PW) (13)

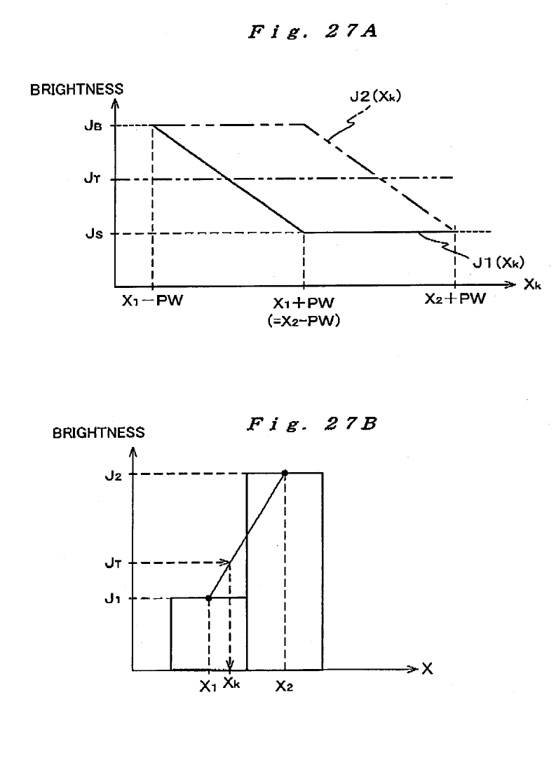

FIG. 27A shows how brightness J1(Xₖ) and J2(Xₖ) given by the equations (10) through (13) vary when the X position Xₖ of the outer edge varies from the edge in the −X direction (X=X₁−PW) of pixel PX1 through the edge in the +X direction (X=X₂+PW) of pixel PX2.

Next, consider how to check whether a pixel in pick-up field VA is in object area SAR or in background area BAR. The brightness differs between a pixel in object area SAR and a pixel in background area BAR. Therefore, it is simple and reasonable to determine, by testing whether or not brightness in the pixel is larger than a threshold value J_{T}, whether a pixel in pick-up field VA is in object area SAR or in background area BAR. The threshold value J_{T} is preferably a value statistically appropriate in discriminating the object area SAR and the background area BAR. The least entropy method above-mentioned provides the threshold value statistically appropriate in discriminating the object area SAR and the background area BAR.

When it is determined that pixel PX1 is in the object area SAR and pixel PX2 is in the background area BAR, the X position Xₖ of the outer edge is given by the equation (14) with brightness J₁ and J₂ of the pixels PX1, PX2 as a picking-up result and the threshold value J_{T} being known,

Xₖ−[(J_{T}−J₁)×X₁+(J₂−J_{T})×X₂]/(J₂−J₁) (14)

The obtained X position Xₖ of the outer edge, as shown in FIG. 27B, is given as the X position of a point on a line joining coordinates (X₁, J₁) and (X₂, J₂) where brightness=J_{T}in the coordinate system whose X axis and Y axis denote X position and brightness respectively. That is, the X position Xₖ of the outer edge given by the equation (14) is the X position of a point which divides internally a line segment joining the center positions X₁, X₂ in the X direction of pixels PX1 and PX2 in proportion to the absolute value of the difference (J_{T}−J₁) between the threshold value J_{T} and brightness J₁ of the pixels PX1, and the absolute value of the difference (J₂−J_{T}) between the threshold value J_{T} and brightness J₂ of the pixels PX2.

While in the above, the case of estimating the X position of the outer edge with an accuracy of sub-pixel when the outer edge of the object is parallel to the Y axis was described, the Y position of the outer edge can be estimated likewise with an accuracy of sub-pixel when the outer edge of the object is parallel to the X axis. Further, when the outer edge of the object is oblique to the X and Y axes, by applying the above-mentioned technique to each of the X and Y directions the two-dimensional position of the outer edge of the object can be estimated with an accuracy of sub-pixel.

That is, by substituting into the equation (14) the threshold value appropriate in discriminating the object area SAR and the background area BAR and the brightness in pixels in the object area SAR and the background area BAR, obtained from the picking-up result, the position of the outer edge of the object can be estimated with an accuracy of sub-pixel.

In subroutine 173 of FIG. 23, the position of the outer edge of a wafer W in pick-up field VAA is estimated. on the basis of the above principle. Note that the threshold value JT_{A} in pick-up field VAA corresponding to the above-mentioned threshold value J_{T} is already calculated in subroutine 172.

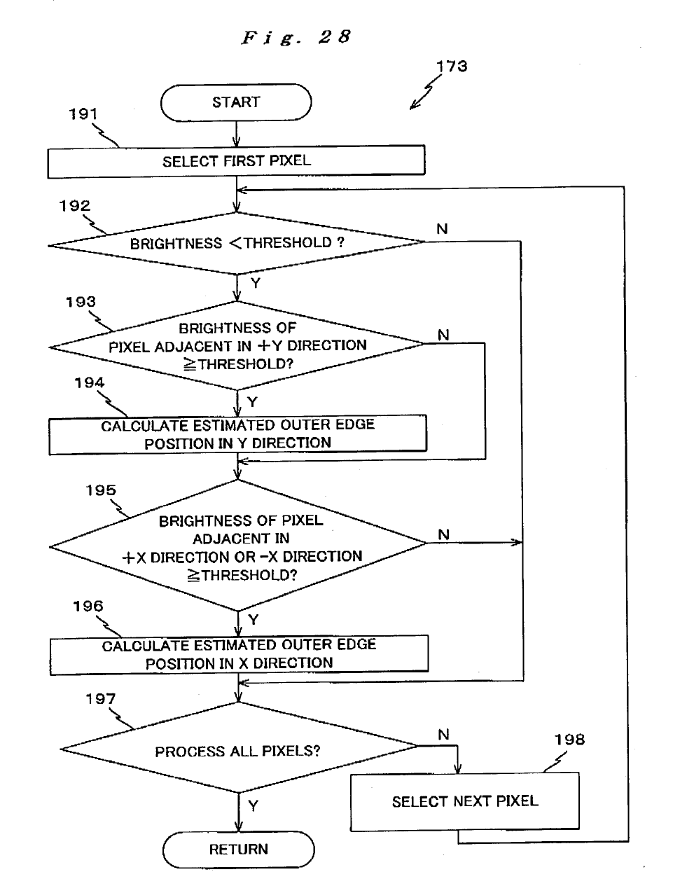

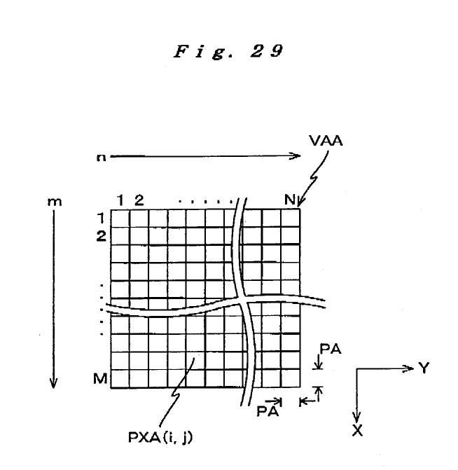

In subroutine 173, as shown in FIG. 28, first in step 191 the edge position estimating unit 153 reads image data in pick-up field VAA and the threshold value JT_{A} from the image data store area 161 and the threshold value store area 162 and extracts the brightness of a first pixel. The picking-up result in pick-up field VAA is, as shown in FIG. 29, represented by a group of brightness JA(m, n) in pixels PXA(m, n) (m−1 through M; n−1 through N) arranged in a matrix with columns extending in the X direction and rows extending in the Y direction, the first pixel being PXA(1, 1). The reason why PXA(1, 1) is selected as the first pixel is that the wafer image area WAA is located on the −Y direction side of pick-up field VAA and the background area WBB on the +Y direction side of pick-up field VAA (see FIG. 22A) and that PXA(1, 1) being on the corner in the −X and −Y directions is almost definitely in the wafer image area WAA. It is remarked that pixel PXA(m, n) is a square having a dimension PA and whose center position is denoted by (XAⱼ, YAⱼ).

Referring back to FIG. 28, subsequently in step 192, the edge position estimating unit 153 checks, by testing whether or not the brightness JA(m, n) of a pixel PXA(m, n) currently being processed (here, PXA(1, 1)) is below the threshold value JT_{A}, whether or not the current pixel is located in the wafer image area WAA. If the answer is NO, it is determined that the outer edge of the wafer image area WAA is not present on the +Y direction side of the current pixel, and the process proceeds to step 197. Meanwhile, if the answer is YES, the process proceeds to step 193.

In the following the case where the answer in step 192 is YES and the process has proceeded to step 193 will be described.

In step 193, the edge position estimating unit 153 checks, by testing whether or not the brightness JA(m, n+1) in a pixel FXA(m, n+1) next in the +Y direction to the pixel PXA(m, n) is equal to or higher than the threshold value JT_{A}, whether or not the pixel next to the pixel PXA(m, n), which is in the wafer image area WAA, is located in the background area BAA. If the answer is NO, the process proceeds to step 195.

Meanwhile, if the answer in step 193 is YES, the process proceeds to step 194. In step 194 the edge position estimating unit 153, on the basis of the above principle, calculates estimated Y position EYA_{m, n} given by the equation (15)

EYA_{m, n}=[(JT_{A}−JA(m, n))×YAₙ+(JA(m, n+1)−JT_{A})×YAₙ₊₁]/(JA(m, n+1)−JA(m, n)) (15)

And the process proceeds to step 195.

In step 195, the edge position estimating unit 153 checks, by testing whether or not the brightness JA(m+1, n) in a pixel PXA(m+1, n) next in the +X direction to the pixel PXA(m, n) and the brightness JA(m−1, n) in a pixel PXA(m−1, n) next in the −X direction to the pixel PXA(m, n) are equal to or higher than the threshold value JT_{A}, whether or not the pixels next to the pixel PXA(m, n), which is in the wafer image area WAA, are located in the background area BAA. Incidentally, in the case of a pixel like PXA(1, n), which has no pixel on its −X direction side, the brightness of only the pixel on its +X direction side is checked, and in the case of pixel PXA(M, n), which has no pixel on its +X direction side, only the brightness JA(M−1, n) of the pixel PXA(M−1, n) is checked in step 195. If the answer in step 195 is NO, the process proceeds to step 197.

Meanwhile, if the answer in step 195 is YES, the process proceeds to step 196, where the edge position estimating unit 153 calculates an estimated X position EXA_{m, n} on the basis of the above principle.

That is, if only for the brightness JA(m+1, n) in the pixel PXA(m+1, n) the answer in step 195 is YES, the edge position estimating unit 153 calculates an estimated X position EXA_{m, n} given by the equation (16)

EXA_{m, n}=[(JT_{A}−JA(m, n))×XAₘ+(JA(m+1, n)−JT_{A})×XAₘ₊₁]/(JA(m+1, n)−JA(m, n)) (16)

And if only for the brightness JA(m−1, n) in the pixel PXA(m−1, n) the answer in step 195 is YES, the edge position estimating unit 153 calculates an estimated X position EXA_{m, n} given by the equation (17)

EXA_{m, n}=[(JT_{A}−JA((m, n))×XAₘ+(JA(m−1, n)−JT_{A})×XAₘ₋₁]/(JA(m−1, n)−JA(m, n)) (17)

And if both for the brightness JA(m+1, n), JA(m−1, n) the answer in step 195 is YES, the edge position estimating unit 153 calculates an estimated X position EXA_{m, n} given by the equation (18)

$${EXA}_{m , n} = \{ [ ( {JT}_{A} - JA ( m , n ) ) \times {XA}_{m} + ( JA ( m + 1 ) , n ) - {JT}_{A} ) \times {XA}_{m + 1} ] / ( JA ( m + 1 ) , n ) - JA ( m , n ) ) + [ ( {JT}_{A} - JA ( m , n ) ) \times {XA}_{m} + ( JA ( m - 1 , n ) - {JT}_{A} ) \times {XA}_{m - 1} ] / ( JA ( m - 1 , n ) - JA ( m , n ) ) \} / 2. \qquad ( 18 )$$

And the process proceeds to step 197.

In step 197, the edge position estimating unit 153 stores the estimated position data in the outer edge position store area 163, which is, it only the estimated Y position EYA_{m, n} is calculated, (XAₘ, EYA_{m, n}) or, it only the estimated X position EXA_{m, n} is calculated, (EXA_{m, n}, YAₙ) or, if both the estimated x position EXA_{m, n} and Y position EYA_{m, n} are calculated, (EXA_{m, n}, EYA_{m, n}). It is noted that the estimated position of the outer edge of the wafer image area WAA in pick-up field VAA is generically denoted by estimated edge position PAᵢ(XAᵢ, YAᵢ) (see FIG. 22A).

Subsequently, in step 197 it is checked whether or not the detection of the outer edge position is completed for all pixels in pick-up field VAA, and if the answer is YES, the process in the subroutine 173 ends, otherwise the process proceeds to step 198.

In the following the case where the answer in step 197 is NO and the process has proceeded to step 198 will be described.

In step 198 the edge position estimating unit 153 selects a next pixel in the following way.

When the pixel with which the detection of the outer edge position in step 192 through 197 is performed most recently is PXA(p, N) (p=1 through (M−1)) and the answer in step 192 is NO, the edge position estimating unit 153 selects PXA(p+1, 1) as a next pixel, and also when the pixel with which the detection of the outer edge position in step 193 through 197 is performed most recently is PXA(p, N−1), selects PXA(p+1, 1) as a next pixel.

Meanwhile, when the pixel with which the detection of the outer edge position in step 193 through 197 is performed most recently is PXA(m, q) (q≠(N−1)) the edge position estimating unit 153 selects PXA(m, q+1) as a next pixel.

After the selection of a next pixel, the process proceeds to step 192.

The process in step 192 through 198 is performed with the next pixel to calculate an estimated edge position PAᵢ(XAᵢ, YAᵢ) of the wafer image area WAA in pick-up field VAA, and if the answer in step 197 is YES, the process of the subroutine 173 ends and the process proceeds to step 174 in FIG. 23.

In step 174 the edge position estimating unit 153 checks whether or not for all pick-up fields VAA, VAB, VAC, estimated edge positions are obtained. At this stage because only for pick-up field VAA estimated edge positions are obtained, the answer is NO and the process proceeds to step 175.

In step 175, the threshold value calculating unit 152 reads image data in a next pick-up field, i.e. pick-up field VAB, from the image data store area 161, and the process proceeds to subroutine 172. Subsequently, the subroutines 172 and 173 are executed, as with image data in pick-up field VAA, to calculate estimated edge positions PBⱼ(XBⱼ, YBⱼ) (see FIG. 22B) of the wafer image area WAB in pick-up field VAB and store them in the outer edge position store area 163.

Next in step 174, the edge position estimating unit 153 checks whether or not for all pick-up fields VAA, VAB, VAC, estimated edge positions are obtained. At this stage because only for pick-up fields VAA, VAB estimated edge positions are obtained, the answer is NO and the process proceeds to step 175.

In step 175, the threshold value calculating unit 152 reads image data in a next pick-up field, i.e. pickup field VAC, from the image data store area 161. As with image data in pick-up field VAB, estimated edge positions PCₖ(XCₖ, YCₖ) (see FIG. 22C) of the wafer image area WAC in pick-up field VAC are calculated and stored in the outer edge position store area 163.

When for all pick-up fields VAA, VAB, VAC, estimated edge positions with an accuracy of sub-pixel are obtained, the answer in step 174 is YES and the process proceeds to step 176.

In step 176, the wafer position information estimating unit 154 reads the estimated edge positions PAᵢ(XAᵢ, YAᵢ), PBⱼ(XBⱼ, YBⱼ), PCₖ(XCₖ, YCₖ) from the outer edge position store area 163 and calculates the center position and rotation about the Z axis of the wafer W. That is, the wafer position information estimating unit 154 estimates the center position of the wafer W by obtaining a circle approximate to the wafer W based on the estimated edge positions PAᵢ(XAᵢ, YAᵢ), PBⱼ(XBⱼ, YBⱼ), PCₖ(XCₖ, YCₖ), which are three sets of estimated edge positions of which each set represents the arc of the wafer W, and estimates the position of the notch N based on a set of estimated edge positions out of the three sets associated with the notch N, and then calculates the rotation about the Z axis of the wafer W based on the center position of the wafer W and the position of the notch N.

The wafer position information estimating unit 154 stores data that denotes the center position and rotation about the Z axis of the wafer W in the wafer position information store area 164. This completes the process of subroutine 105, and the process proceeds to step 106 in FIG. 7.

After measurement in step 106 for preparation for exposure in the same manner as in the first embodiment, scan exposure is performed on each shot area in step 107. And in step 108 after the wafer stage WST is moved to an unloading position, an unloader (not shown) unloads the wafer w from the substrate table 18. This completes exposure of the wafer W.

As described above, according to this embodiment because a position in a discrete distribution of brightness, the picking-up result, where brightness is estimated to be at a threshold value is taken as an estimated position of the outer edge of the wafer W, the position of the outer edge of the wafer W can be estimated with an accuracy of sub-pixel.

Moreover, based on the accurately estimated position of the outer edge of the wafer W, information that denotes the center position and rotation about the Z axis of the wafer W is obtained.

Moreover, according to this embodiment a pattern is transferred onto shot areas while controlling the position of the wafer W based on position information of the wafer W detected accurately by use of the above position detecting method. Therefore, a pattern can be accurately transferred onto shot areas.

In this embodiment, brightness is assumed to be uniform in each of the wafer image area and the background area in a pick-up field. However, even if brightness is not uniform in one or both of the wafer image area and the background area, when the minimum of brightness in one area is larger than the maximum of brightness in the other area, by estimating the position of the outer edge of the wafer image area in the manner described in the above embodiment, the position of the outer edge of the wafer image area can be estimated with a higher accuracy than is of a pixel in the prior art.

In this embodiment, during performing the edge position estimation on pixels sequentially in the +Y direction at an X position, when the brightness of a pixel is larger than the threshold value, the outer edge is immediately determined to exist there, and the Y position thereof is calculated. However, when the brightness of a given number of consecutive pixels in the +Y direction is larger than the threshold value, the outer edge may be determined to exist in the first one of the consecutive pixels, so that the Y position thereof is calculated. This can increase tolerance to noise in the picking-up result. Needless to say, the above method of extracting the outer edge can be applied to extracting the outer edge in the X direction.

While in this embodiment the edge position estimation is started from a pixel that is necessarily in the wafer image area, it may be started from a pixel that is necessarily in the background area. Further, while in this embodiment the edge position estimation is performed on pixels sequentially in the +Y direction at an X position, it may be performed on pixels sequentially in the +X direction at a Y position.

While in this embodiment the edge position estimation is performed on all pixels, if a range in which the outer edge is present is known, it may be performed on pixels in the range.

While in this embodiment the threshold value is calculated by use of the least-entropy method, another statistical method may be used. For example, in the case where the object image area and the background area are definitely known in a pick-up field and in each area there is no big variation in brightness, the middle value between means of brightness in the object image area and the background area may be used as the threshold value.

While in this embodiment the wafer W is loaded such that its notch is oriented in the +Y direction in FIG. 20, this invention can be applied to the case where a wafer having a diameter of 12 inches is loaded such that its notch is oriented in the −X direction, in which case the CCD cameras 40A, 40B, 40C are arranged so as to be able to pick up the images of the notch and parts of the wafer's periphery respectively that are located angular distances of +45 and −45 degrees apart from the notch's center.

Further, in order to be able to deal with it whether the notch is oriented in the +Y or −X direction, five CCD cameras may be arranged such that they are located an angular distance of +45 degrees apart from one after another counterclockwise, the second one of which is above a part directed in the +Y direction of the wafer's periphery.

While in this embodiment the wafer W is one having a diameter of 12 inches, this invention can be applied to a wafer having a diameter of 8 inches.

Further, not being limited to the above arrangement, as long as one of the CCD cameras 40A, 40B, 40C is arranged so as to be able to pick up the image of the notch N, the arrangement of the others may be arbitrary.

Although in this embodiment the wafer W has a notch, this invention can be applied to a wafer having a orientation flat, in which case three CCD cameras are arranged so as to be able to pick up the images of both ends of the orientation flat and a part of the wafer's periphery, e.g. a part directed in the −X direction if the orientation flat is directed in the +Y direction.

<<A Third Embodiment>>

Next, the exposure apparatus of a third embodiment will be described. This embodiment differs from the exposure apparatus of the second embodiment in the construction and operation of the wafer shape computing unit 51. The description in the below will focus mainly on the differences. The same numerals or symbols as in the second embodiment indicate elements which are the same as or equivalent to those in the second embodiment, and no description thereof will be provided.

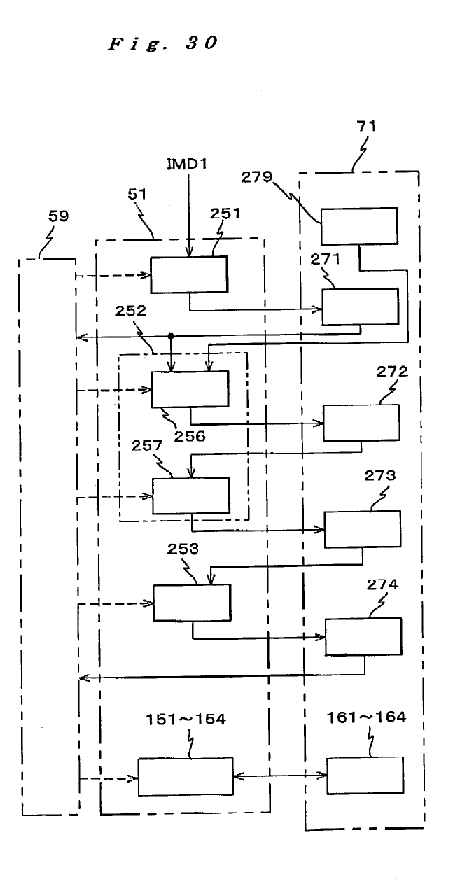

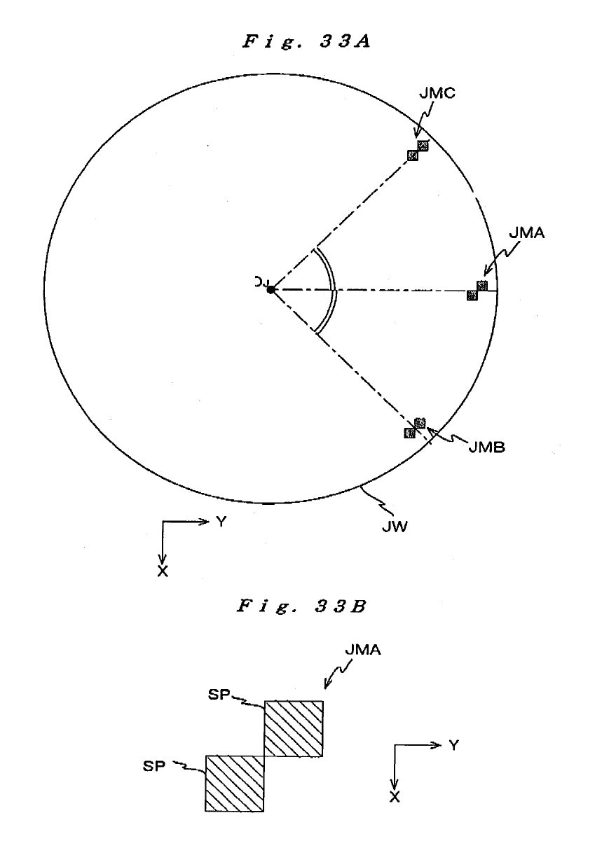

The wafer shape computing unit 51 of this embodiment, as shown in FIG. 30, comprises the units 151 through 154 in the second embodiment, (a) an image data collecting unit 251 for collecting image data IMD1 from the pre-alignment detection system RAS, (b) a position information processing unit 252 for obtaining position information of cross marks JMA, JMB, JMC (see FIG. 33B) formed on a measurement wafer JW later-described based on the results of the CCD cameras 40A, 40B, 40C picking up three parts of the measurement wafer JW's periphery, and (c) a correction information calculating unit 253 for calculating correction information for the CCD cameras 40A, 40B, 40C based on the position information calculated by the position information processing unit 252. The position information processing unit 252 comprises (i) a correlation calculating unit 256 for calculating a correlation between a picking-up result and a template pattern and (ii) a mark position calculating unit 257 for calculating position information of the cross marks based on the correlation calculated.

A wafer shape computation data store area 71 of this embodiment comprises the areas 161 through 164 in the second embodiment, an image data store area 271, a correlation value store area 272, a position information store area 273, a correction information store area 274, and a template pattern store area 279.

Needless to say, the image data collecting units 251 and 151 may be a same unit, and the image data store areas 271 and 161 may be a same area. It is noted that in FIG. 30 a solid arrow indicates a data flow and a dashed arrow indicates a control flow.

While, in this embodiment, the wafer shape computing unit 51 comprises the various units as described above, the main control system 20 may be a computer system where the functions of the various units of the wafer shape computing unit 51 are implemented as program modules installed therein, as in the second embodiment.

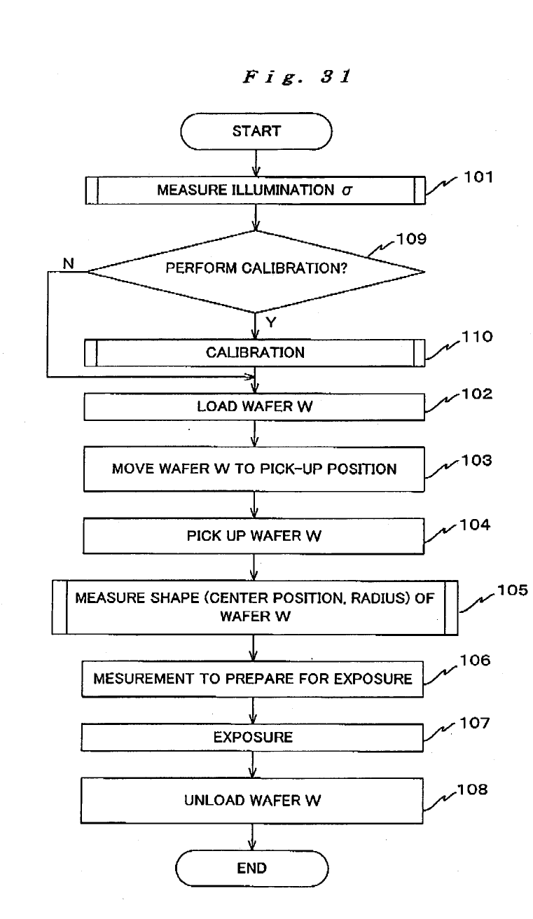

The exposure operation of the exposure apparatus 100 of this embodiment will be described in the following with reference to a flow chart in FIG. 31 and other figures as needed. In this embodiment the correction of the pre-alignment detection system RAS means the correction of magnification and field rotation of each of the CCD cameras 40A, 40B, 40C.

Hereinafter, a coordinate system (X, Y) denotes a two-dimensional coordinate system defined by the measurement axes of the wafer interferometers 28X, 28Y. Further, coordinate systems (XA, YA), (XB, YB), (XC, YC) denote two-dimensional coordinate systems defined according to the arrangement of pixels in the pick-up fields of the CCD cameras 40A, 40B, 40C. Yet further, a numeral suffix affixed to X, Y, XA, etc., indicates a value of a coordinate.

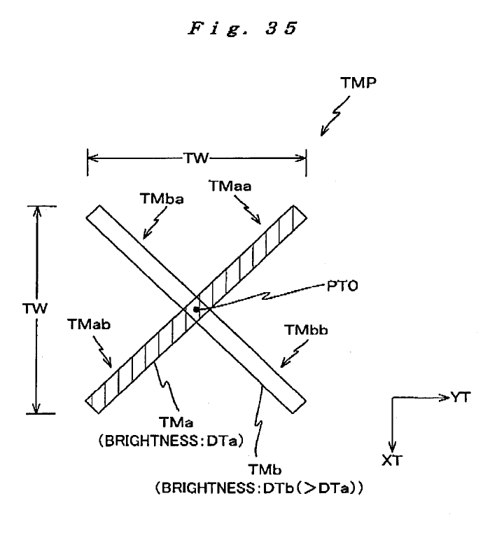

It is assumed that a template pattern TMP later-described (see FIG. 35) is stored in the template pattern store area 279.

The illumination σ is measured in subroutine 101 of FIG. 31 as in the second embodiment, and step 109 checks whether or not the pre-alignment detection system RAS is to be corrected. If the answer in step 109 is YES, the process proceeds to subroutine 110. The pre-alignment detection system RAS is corrected upon installation, maintenance, etc., of the exposure apparatus 100, at which time the answer in step 109 is YES. Meanwhile, if the answer in step 109 is NO, the process proceeds to step 102. During processing a lot of wafers no correction of the pre-alignment detection system RAS occurs, at which time the answer in step 109 is NO. In the below the case where the answer in step 109 is YES will be described.

Next, in subroutine 110 the correction of the pre-alignment detection system RAS, i.e., the CCD cameras 40A, 40B, 40C used in pre-alignment is performed. It is assumed as a premise that the CCD cameras 40A, 40B, 40C are arranged such that the camera 40A is located above part of a wafer W's periphery directed in the +Y direction, and the cameras 40B, 40C are angular distances of −45 and +45 degrees respectively apart from the camera 40A along the wafer W's outer edge.

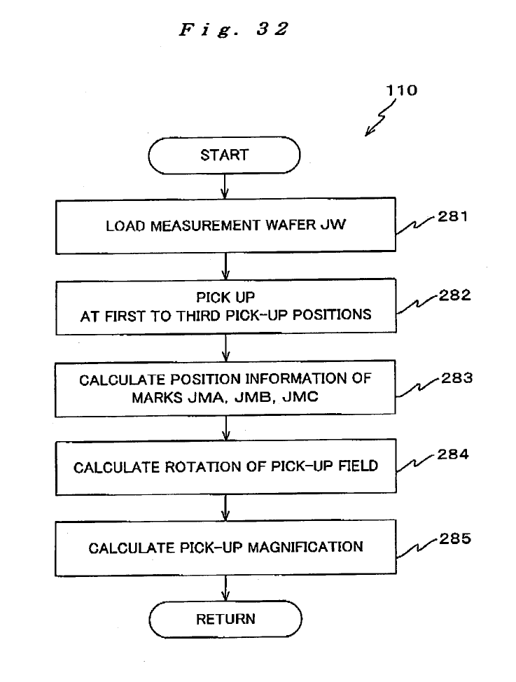

In subroutine 110, first in step 281 as shown in FIG. 32, the wafer loader (not shown) loads the measurement wafer JW onto the wafer holder 25 on the substrate table 18 at a wafer loading point, to which the controller 59 has moved the wafer stage WST via the stage control system 19 and the wafer stage driving unit 21 based on position information (or speed information) from the wafer interferometer 28.

The measurement wafer JW has the three cross marks JMA, JMB, JMC formed on the surface of the periphery thereof as shown in FIG. 33A. The three cross marks JMA, JMB, JMC each have two square patterns SP touching each other at a point as representatively shown by the cross mark JMA in FIG. 33B. As shown in FIG. 33A, a line joining the center of the cross mark JMA and the center O_{J} of the measurement wafer JW makes an angle of substantially 45 degrees with a line joining the center of the cross mark JMB and the center O_{J} of the measurement wafer JW and with a line joining the center of the cross mark JMB and the center θ_{J} of the measurement wafer JW.

Next, in step 282 the controller 59 moves the wafer stage WST via the stage control system 19 and the wafer stage driving unit 21 based on position information (or speed information) from the wafer interferometer 28 so as to position the measurement wafer JW at a first through a third position sequentially and picks up the images thereof by means of the CCD cameras 40A, 40B, 40C.

In step 282, first the controller 59 moves the wafer stage WST so as to position the measurement wafer JW at the first position (X₁, Y₁) and picks up the images of three parts of the measurement wafer JW's periphery which include the cross marks JMA, JMB, JMC respectively by means of the CCD cameras 40A, 40B, 40C.

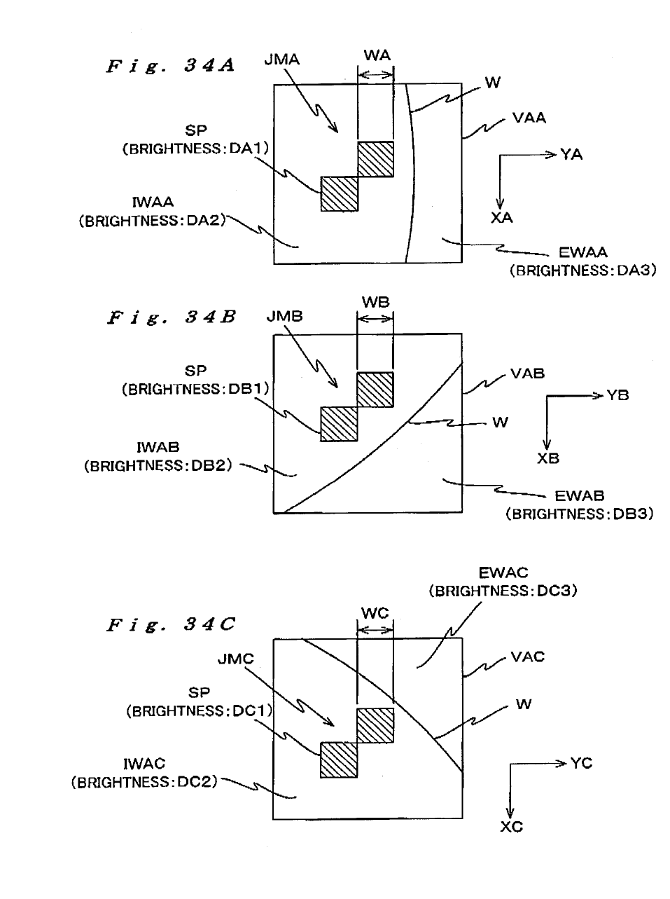

FIGS. 34A through 34C show the examples of the picking-up results of the CCD cameras 40A, 40B, 40C. The picking-up result of the CCD camera 40A shown in FIG. 34A is the image, in field VAA, of a part of the measurement wafer JW's periphery directed in the +Y direction, which image has an inside wafer area IWAA including the cross mark JMA and an outside wafer area EWAA. Let WA indicate the dimension of the pattern SP of the cross mark JMA.

Further, let DA1 and DA2 indicate brightness of pixels in the patterns SP of the cross mark JMA and brightness of pixels outside the patterns SP in the inside wafer area IWAA respectively, where DA2 is less than DA1. And it is assumed that the image of the outside wafer area EWAA can be discriminated from the image of the inside wafer area IWAA by use of image processing. Further, let DA3 indicate brightness of pixels in the outside wafer area EWAA, where DA3 is not equal to DA1 and DA2.

The picking-up result of the CCD camera 40B shown in FIG. 34B is the image, in field VAD, of a part of the measurement wafer JW's periphery an angular distance of −45 degrees apart from the field VAA, which image has an inner wafer area IWAB including the cross mark JMB and an outer wafer area EWAB. Let DB1, DB2 and DB3 indicate brightness of pixels in the patterns SP of the cross mark JMB, brightness of pixels outside the patterns SP in the inner wafer area IWAB, and brightness of pixels in the outer wafer area EWAB respectively, where DB2 is less than DB1, and DB3 is not equal to DB1 and DB2. Let WB indicate the dimension of the pattern SP of the cross mark JMB.

The picking-up result of the CCD camera 40B shown in FIG. 34C is the image, in field VAC, of a part of the measurement wafer JW's periphery an angular distance of +45 degrees apart from the field VAA, which image has an inner wafer area IWAC including the cross mark JMC and an outer wafer area EWAC. Let DC1, DC2 and DC3 indicate brightness of pixels in the patterns SP of the cross mark JMC, brightness of pixels outside the patterns SP in the inner wafer area IWAC, and brightness of pixels in the outer wafer area EWAC respectively, where DC2 is less than DC1, and DC3 is not equal to DC1 and DC2. Let WC indicate the dimension of the pattern SP of the cross mark JMC.

The picking-up results as image data IMD1 are supplied to the main control system 20, of which the image data collecting units 251 receives the image data IMD1 and stores it together with picking-up position (X₁, Y₁) data in the image data store areas 271.

Next, the water stage WST is moved in the +X direction to the second picking-up position (X₂, Y₂), which is a distance ΔX apart from the first picking-up position (X₁, Y₁) (X₂=X₁+ΔX and Y₂=Y₁) and where the cross marks JMA, JMB, JMC still lie in the pick-up fields of the CCD cameras 40A, 40B, 40C respectively. In the same way as for the first picking-up position (X₁, Y₁), the images of three parts of the measurement wafer JW's periphery which include the cross marks JMA, JMB, JMC respectively are picked up by means of the CCD cameras 40A, 40B, 40C. In the second picking-up position (X₂, Y₂), brightness of pixels in the patterns SP of the cross marks JMA, JMB, JMC and brightness of pixels outside the patterns SP in the inner wafer areas IWAA, IWAB, IWAC, and brightness of pixels in the outer wafer areas EWAA, EWAB, EWAC are the same as those in the first picking-up position (X₁, Y₁). The picking-up results as image data IMD1 are supplied to the main control system 20, which stores it together with picking-up position (X₂, Y₂) data in the image data store areas 271.

Subsequently, the wafer stage WST is moved in the +Y direction to the third picking-up position (X₃, Y₃), which is a distance ΔY apart from the second picking-up position (X₂, Y₂) (X₃=X₂ and Y₃=Y₂+ΔY) and where the cross marks JMA, JMB, JMC still lie in the pick-up fields of the CCD cameras 40A, 40B, 40C respectively. In the same way as for the first picking-up position (X₁, Y₁), the images of three parts of the measurement wafer JW's periphery which include the cross marks JMA, JMB, JMC respectively are picked up by means of the CCD cameras 40A, 40B, 40C. In the third picking-up position (X₃, Y₃), brightness of pixels in the patterns SP of the cross marks JMA, JMB, JMC and brightness of pixels outside the patterns SP in the inner wafer areas IWAA, IWAB, IWAC, and brightness of pixels in the outer wafer areas EWAA, EWAB, EWAC are the same as those in the first picking-up position (X₁, Y₁) . The picking-up results as image data IMD1 are supplied to the main control system 20, which stores it together with picking-up position (X₃, Y₃) data in the image data store areas 271.

Referring back to FIG. 32, next in step 283 position information of the cross marks JMA, JMB, JMC in the first through third picking-up positions are calculated. In the calculation, the mark position calculating unit 256, first, reads the picking-up result of the CCD camera 40A in the first picking-up position (X₁, Y₁) from the image data store areas 271 and the template pattern TMP shown in FIG. 35 from the template pattern store area 279.

The template pattern TMP is composed of four lines TMaa, TMab, TMba, TMbb extending radially from a reference point PT0 as shown in FIG. 35, the lines TMaa, TMab of which form a first pattern TMa and the lines TMba, TMbb of which form a second pattern TMb, which patterns TMa, TMb are perpendicular to each other at the reference point PT0. The reference point PT0 is in the middle of the first pattern TMa and in the middle of the second pattern TMb. Further, brightness of the first pattern TMa is uniform therein and is indicated by DTa; brightness of the first pattern TMb is uniform therein and is indicated by DTb (>DTa). Yet further, the XT and YT axes of a template coordinate system (XT, YT) make an angle of 45 degrees with the first pattern TMa and the second pattern TMb, whose line widths are almost the same as the dimension of the pixel.

Still further, let TW indicate the dimensions in the XT and YT directions of the template pattern TMP, which TW is set to be smaller than twice the dimension WA, WB, WC in the picking-up result of the pattern SP of each cross mark JMA, JMB, JMC, that is, the predicted dimension of each cross mark JMA, JMB, JMC. The dimensions TW of the template pattern TMP can be magnified and reduced to be smaller than the dimension of each cross mark JMA, JMB, JMC.

Next, the mark position calculating unit 256 extracts the cross mark JMA from the picking-up result of the CCD camera 40A in the first picking-up position (X₁, Y₁). While moving two-dimensionally the reference point PT0 of the template pattern TMP in the coordinate system (XA, YA) with the XT axis being parallel to the XA axis in such a range that the whole template pattern TMP covers part of the extracted cross mark JMA, correlation between the template pattern TMP and the picking-up result in each position is calculated.

The correlation may be normalized correlation between the template pattern TMP and a picking-up result or the sum of the absolute values of the differences in brightness in positions between the template pattern TMP and a picking-up result, and the latter is used in this embodiment.

The mark position calculating unit 256 stores the calculated correlations in the correlation value store area 272.

Subsequently, the mark position calculating unit 257 reads from the correlation value store area 272 the correlations, which form a function of the coordinates (XA, YA), and obtains coordinates (XA₁, YA₁) where the correlation function takes on a minimum. Incidentally, if the correlation is normalized correlation, the mark position calculating unit 257 obtains coordinates where the correlation function takes on a maximum.

The correlation function between the template pattern TMP and the picking-up result takes on a minimum when the center of the cross mark JMA coincides with the reference point PT0, and obtaining the coordinates (XA₁, YA₁) obtains the center position in the coordinate system (XA, YA), i.e., position information of the cross mark JMA from the picking-up result of the CCD camera 40A in the first picking-up position (X₁, Y₁). The mark position calculating unit 257 stores the obtained position information (XA₁, YA₁) in the position information store area 273.

Next, in the same way as for the picking-up result of the CCD camera 40A, position information (XB₁, YB₁) of the cross mark JMB in the coordinate system (XB, YB) and position information (XC₁, YC₁) of the cross mark JMC in the coordinate system (XC, YC) are obtained from the picking-up results of the CCD cameras 40B, 40C in the first picking-up position (X₁, Y₁) and are stored in the position information store area 273.

Subsequently, in the same way as with the first picking-up position (X₁, Y₁), position information (XA₂, YA₂) of the cross mark JMA in the coordinate system (XA, YA), position information (XB₂, YB₂) of the cross mark JMB in the coordinate system (XB, YB) and position information (XC₂, YC₂) of the cross mark JMC in the coordinate system (XC, YC) are obtained from the picking-up results of the CCD cameras 40A, 408, 40C in the second picking-up position (X₂, Y₂). Further, in the same way as with the first picking-up position (X₁, Y₁), position information (XA₃, YA₃) of the cross mark JMA in the coordinate system (XA, YA), position information (XB₃, YB₃) of the cross mark JMB in the coordinate system (XB, YB) and position information (XC₃, YC₃) of the cross mark JMC in the coordinate system (XC, YC) are obtained from the picking-up results of the CCD cameras 40A, 40B, 40C in the second picking-up position (X₃, Y₃), and the obtained position information (XA₂, YA₂), (XB₂, YB₂), (XC₂, YC₂), (XA₃, YA₃), (XB₃, YB₃), (XC₃, YC₃) are stored in the position information store area 273.

Referring back to FIG. 32, next in step 284, the rotation angles of fields of the CCD cameras 40A, 40B, 40C, that is, the field coordinate systems (XA, YA), (XB, YB), (XC, YC) with respect to the stage coordinate system (X, Y) are calculated. In the calculation of the rotation angles, the correction information calculating unit 253 reads the position information (XAⱼ, YAⱼ), (XBⱼ, YBⱼ), (XCⱼ, YCⱼ) (j=1 through 3) from the position information store area 273.

Subsequently, the correction information calculating unit 253 calculates a first estimated rotation angle θ1_{A} of the field coordinate system (XA, YA) with respect to the stage coordinate system (X, Y) given by the equation (19), where it is considered that variation of the position information of the cross mark JMA from (XA₁, YA₁) to (XA₂, YA₂) in the field coordinate system (XA, YA) corresponds to the movement of the wafer stage WST by the distance ΔX in the +X direction in the stage coordinate system (X, Y),

θ1_{A}=tan⁻¹[(YA₂−YA₁)/(XA₂−XA₁)] (19)

Because variation of the position information of the cross mark JMA from (XA₂, YA₂) to (XA₃, YA₃) in the field coordinate system (XA, YA) corresponds to the movement of the wafer stage WST by the distance ΔY in the +Y direction in the stage coordinate system (X, Y), the correction information calculating unit 253 calculates a second estimated rotation angle θ2_{A} of the field coordinate system (XA, YA) with respect to the stage coordinate system (X, Y) given by the equation (20)

θ2_{A}=cot⁻¹[(YA₃−YA₃)/(XA₃−XA₂)] (20)

And the correction information calculating unit 253 calculates a rotation angle θ_{A} of the field coordinate system (XA, YA) with respect to the stage coordinate system (X, Y) given by the equation (21)

θ_{A}=(θ1_{A}+θ2_{A})/2 (21)

The correction information calculating unit 253 stores the calculated rotation angle θ_{A} in the correction information store area 274.

Next, the correction information calculating unit 253 calculates a rotation angle θ_{B} of the field coordinate system (XB, YB) with respect to the stage coordinate system (X, Y) and a rotation angle θ_{C} of the field coordinate system (XC, YC) with respect to the stage coordinate system (X, Y) given by the equations (22) and (23) respectively,

θ_{B}={tan⁻¹[(YB₂−YB₁)/(XB₂−XB₁)]+cot⁻¹[(YB₃−YB₂)/(XB₃−XB₂)]}/2 (22)

θ_{C}={tan⁻¹[(YC₂−YC₁)/(XC₂−XC₁)]+cot⁻¹[(YC₃−YC₂)/(XC₃−XC₂)]}/2 (23)

The correction information calculating unit 253 stores the calculated rotation angles θ_{B}, θ_{C} in the correction information store area 274.

Next, in step 285 the pick-up magnifications of the CCD cameras 40A, 40B, 40C are calculated. In the calculation the correction information calculating unit 253, first, calculates a magnification MXA in the XA direction of the CCD camera 40A given by the equation (24) based on the position information (XA₁, YA₁), (XA₂, YA₂) of the cross mark JMA, the rotation angle θ_{A}, and the distance ΔX from the first picking-up position (X₁, Y₁) to the second picking-up position (X₂, Y₂) in the movement in the +X direction of the wafer stage WST,

MXA=(XA₂−XA₁)/(ΔX·cosθ_{A}) (24)

Subsequently, the correction information calculating unit 253 calculates a magnification MYA in the YA direction of the CCD camera 40A given by the equation (25) based on the position information (XA₂, YA₂), (XA₃, YA₃) of the cross mark JMA, the rotation angle θ_{A}, and the distance ΔY from the first picking-up position (X₂, Y₂) to the second picking-up position (X₃, Y₃) in the movement in the +Y direction of the wafer stage WST,

MYA=(YA₃−YA₂)/(ΔY−cosθ_{A}) (25)

And the correction information calculating unit 253 stores the calculated magnifications MXA, MYA in the correction information store area 274.

Next, in the same way as for the CCD camera 40A, the correction information calculating unit 253 calculates magnifications MXB, MYB in the XB and YB directions of the CCD camera 40B given by the equations (26) and (27) and magnifications MXC, MYC in the XC and YC directions of the CCD camera 40B given by the equations (28) and (29),

MXB=(XB₂−XB₁)/(ΔX−cosθ_{B}) (26)

MYB=(YB₃−YB₂)/(ΔY−cosθ_{B}) (27)

MXC=(XC₂−XC₁)/(ΔX−cosθ_{C}) (28)

MYC =(YC₃−YC₂)/(ΔY−cosθ_{C}) (29)

And the correction information calculating unit 253 stores the calculated magnifications MXB, MYB, MXC, MYC in the correction information store area 274.

After the rotation angles of the fields and the pickup magnifications of the CCD cameras 40A, 40B, 40C have been calculated, the process of subroutine 110 ends and the process proceeds to step 102 in FIG. 31.

Subsequently, in steps 102 through 104, a reticle R and a wafer W are loaded onto the reticle stage RST and the substrate table 18 respectively, and after the wafer W is moved to a pick-up position, the pre-alignment sensors 40A, 40B, 40C pick up the images of the wafer W's periphery. Then in subroutine 105 the center position and rotation about the Z axis of the wafer W are calculated in the same way as in the second embodiment.

After measurement in step 106 for preparation for exposure in the same manner as in the second embodiment, scan exposure is performed on each shot area in step 107. And in step 108 after the wafer stage WST is moved to an unloading position, an unloader (not shown) unloads the wafer W from the substrate table 18. This completes exposure of the wafer W.

As described above, in this embodiment position information of the cross marks JMA, JMB, JMC formed on the measurement wafer JW is detected by picking up the images of areas which include the cross marks JMA, JMB, JMC respectively and performing template matching by use of the template pattern TMP. Here, the cross marks JMA, JMB, JMC each are a mark having four areas divided by boundaries extending from the mark's center, and the template pattern TMP has the four line pattern elements, which extend through the respective four areas of the cross mark when in a picking-up result the center of the cross mark coincides with the reference point PT0 thereof and have brightness according to the respective four areas. Therefore, position information of the mark can be detected accurately and quickly because of using the template pattern according to the mark's shape and because of the number of pixel data being small with which correlation of the template pattern is calculated.

Further, because the template pattern TMP's four line pattern elements substantially bisect the respective four areas of the cross mark, even when the measurement wafer JW has been rotated a bit about its normal direction (the Z direction), the position information of the cross marks JMA, JMB, JMC can be detected accurately.

Still further, because brightness of the template pattern TMP's four line pattern elements is set according to that of the respective four areas, by obtaining a position where the correlation takes on a maximum (or local maximum) or a minimum (local minimum), the position information of the cross marks JMA, JMB, JMC can be detected accurately.

Yet further, because the CCD cameras 40A, 40B, 40C of the pre-alignment detection system RAS detect the position information of a wafer W which cameras have been corrected based on the results of accurately detecting positions of the cross marks JMA, JMB, JMC, a pattern on the reticle R can be accurately transferred onto the wafer W.

While in the above embodiment the X-shape template pattern TMP is used because the cross mark has the four areas around its center, a T-shaped template pattern may be used which has three line pattern elements extending in a letter T from its reference point.

While in the above embodiment the cross marks JMA, JMB, JMC are used which each have four areas divided by boundaries extending from the mark's center, a mark can be used which has three or more areas divided by three or more boundary lines extending from the mark's specific point, in which case a template pattern having three or more line pattern elements extending radially from its reference point may be used.

While in the above embodiment the width of the line pattern elements is almost the same as the dimension of the pixel, it may be larger than the dimension of the pixel.

Further, instead of the sum of the absolute values of the differences in pixels, or the normalized correlation, in brightness between a picking-up result and the template pattern TMP, the sum of the absolute values of the differences, or the normalized correlation, in brightness in line pattern elements between a picking-up result and the template pattern TMP may be used.

In the above embodiment instead of the line pattern elements, curve patterns may be used as long as they divide the respective areas of the mark when the center of the mark coincides with the reference point of the template pattern.

Although in the above embodiments the measurement wafer JW held on the wafer holder 25 is viewed by use of the pre-alignment detection system RAS in order to correct the CCD cameras 40A, 40B, 40C and pre-alignment is performed on a wafer W held on the wafer holder 25, the viewing of the measurement wafer JW and the pre-alignment of a wafer W may be performed while each of them is being held on the wafer loader before being loaded onto the wafer holder 25, in which case during pre-alignment, part of measurement for preparation for exposure (reticle alignment, base line measurement, etc.) can be performed. Further, this invention can be applied to a pre-alignment apparatus disposed on the path for the wafer loader to transport wafers on.

In addition, while the above embodiments describe the case of a scan-type exposure apparatus, this invention can be applied to any exposure apparatus for manufacturing devices or liquid crystal displays such as a reduction projection exposure apparatus using ultraviolet light or soft X-rays having a wavelength of about 10 nm as the light source, an X-ray exposure apparatus using light having a wavelength of about 1 nm, and an exposure apparatus using EB (electron beam) or an ion beam, regardless of whether it is of a step-and-repeat type, a step-and-scan type, or a step-and-stitching type.

In addition, while the above embodiments describe an exposure apparatus, the present invention can be applied to other units than exposure apparatuses such as a unit for viewing objects using a microscope and a unit used to detect the positions of objects in an assembly line, process line or inspection line.

<<Manufacture of Devices>>

Next, the manufacture of devices (semiconductor chips such as ICs or LSIs, liquid crystal panels, CCD's, thin magnetic heads, micro machines, or the like) by using the exposure apparatus and method according to any of the first through third embodiments will be described with using the manufacture of semiconductor devices as an example.

In a design steps function/performance design for the devices (e.g., circuit design) is performed and pattern design is performed to implement the function. In a mask manufacturing step, masks on which a different sub-pattern of the designed circuit is formed are produced. In a wafer manufacturing step, wafers are manufactured by using silicon material or the like.

In a wafer processing step, actual circuits and the like are formed on the wafers by lithography or the like using the masks and the wafers prepared in the above steps, as will be described below.

This wafer processing step comprises a pre-process and a post-process described later, which are repeated. The pre-process comprises an oxidation step where the surface of a wafer is oxidized, a CVD step where an insulating film is formed on the wafer surface, an electrode formation step where electrodes are formed on the wafer by vapor deposition, and an ion implantation step where ions are implanted into the wafer, which steps are selectively executed in accordance with the processing required in each repetition in the wafer processing step.

When the above pre-process is completed in each repetition in the wafer processing step, the post-process is executed in the following manner. In a resist coating step, the wafer is coated with a photosensitive material (resist). In an exposure step, an exposure apparatus according to any of the first through third embodiments transfers a sub-pattern of the circuit on a mask onto the wafer. In a development step, the exposed wafer is developed. In an etching step, an uncovered member of portions other than portions on which the resist is left is removed by etching. In a resist removing step, the unnecessary resist after the etching is removed.

By repeating the pre-process and the post-process from the resist coating step through the resist removing step, a multiple layer circuit pattern is formed on each shot area of the wafer.

After the wafer process, in an assembly step, the devices are assembled from the wafer processed in the wafer processing step. The assembly step includes processes such as dicing, bonding, and packaging (chip encapsulation).

Finally, in an inspection step, an operation test, durability test, and the like are performed on the devices. After these steps, the process ends and the devices are shipped out.

In the above manner, the devices on which a fine pattern is accurately formed are manufactured with high productivity.

While the above-described embodiments of the present invention are the presently preferred embodiments thereof, those skilled in the art of lithography systems will readily recognize that numerous additions, modifications, and substitutions may be made to the above-described embodiments without departing from the spirit and scope thereof. It is intended that all such modifications, additions, and substitutions fall within the scope of the present invention, which is best defined by the claims appended below.

What is claimed is:

1. An image processing method which comprises acquiring an image of a plurality of areas of which two adjacent areas have different image characteristics from each other; and analyzing said image with using the difference between image characteristics of said two adjacent areas to obtain information about a boundary between said two adjacent areas, wherein
said image includes first and second areas which have intrinsic image patterns different from each other and between which the boundary cannot be detected as a continuous line based on the differences between individual pixel data value, and
said analyzing said image comprises:
calculating a texture characteristic's value in each position of a texture analysis window of a predetermined size based on pixel data in said texture analysis window, while moving said texture analysis window; and
estimating a boundary between said first and second areas based on a distribution of the texture characteristic's values calculated in said calculating a texture characteristic's value, and
when it is known that a specific area is a part of said first area in said image, said calculating a texture characteristic's value comprises:
calculating said texture characteristic's value while changing a position of said texture analysis window in said specific area and examining how said texture characteristic's value in said specific area varies according to the position of said texture analysis window; and
calculating said texture characteristic's value while changing a position of said texture analysis window outside said specific area.

2. The image processing method according to claim 1, wherein at least one of intrinsic patterns of said first and second areas is known.

3. The image processing method according to claim 2, wherein the size of said texture analysis window is determined according to said known intrinsic pattern.

4. The image processing method according to claim 1, wherein said texture characteristic's value is at least one of mean and variance of pixel data in said texture analysis window.

5. A detecting method with which to detect characteristic information of an object based on a distribution of light through said object when illuminating said object, said detecting method comprising:
processing an image formed by said light through said object with the image processing method according to claim 1; and
detecting characteristic information of said object based on the processing result of said processing an image.

6. The detecting method according to claim 5, wherein the characteristic information of said object is shape information of said object.

7. The detecting method according to claim 5, wherein the characteristic information of said object is position information of said object.

8. An exposure method with which to transfer a given pattern onto a substrate, said exposure method comprising:
detecting position information of said substrate with the detecting method according to claim 7; and
transferring said given pattern onto said substrate while controlling a position of said substrate based on the position information of said substrate detected in said detecting position information of said substrate.

9. The detecting method according to claim 5, wherein said object is at least one optical element, and the characteristic information of said object is optical characteristic information of said at least one optical element.

10. An exposure method with which to transfer a given pattern onto a substrate by illuminating with an exposure beam via an optical system, said exposure method comprising:
detecting optical characteristic information of said optical system with the detecting method according to claim 9; and
transferring said given pattern onto said substrate based on the detecting result of said detecting optical characteristic information.

11. An image processing method which comprises acquiring an image of a plurality of areas of which two adjacent areas have different image characteristics from each other; and analyzing said image with using the difference between image characteristics of said two adjacent areas to obtain information about a boundary between said two adjacent areas, wherein
said image includes first and second areas which have intrinsic image patterns different from each other and between which the boundary cannot be detected as a continuous line based on the differences between individual pixel data, and
said analyzing said image comprises:
determining weight information which is assigned to each of pixels in a square texture analysis window, and which is defined by a ratio of an inscribed circle area of said texture analysis window to a whole area of a rectangular sub-area, for each of said rectangular sub-areas into which said texture analysis window is divided according to each pixel;
calculating a texture characteristic's value in each position of said texture analysis window based on said weight information and said each pixel data in said texture analysis window, while moving said texture analysis window; and
estimating a boundary between said first and second areas based on a distribution of the texture characteristic's values calculated in said calculating a texture characteristic's value.

12. The image processing method according to claim 11, wherein said weight information further includes additional weight information according to the type of texture analysis.

13. The image processing method according to claim 11, wherein said texture characteristic's value is at least one of weighted mean and weighted variance of pixel data in said texture analysis window.

14. A detecting method with which to detect characteristic information of an object based on a distribution of light through said object when illuminating said object, said detecting method comprising:
processing an image formed by said light through said object with the image processing method according to claim 11; and
detecting characteristic information of said object based on the processing result of said processing an image.

15. The detecting method according to claim 14, wherein the characteristic information of said object is shape information of said object.

16. The detecting method according to claim 14, wherein the characteristic information of said object is position information of said object.

17. An exposure method with which to transfer a given pattern onto a substrate, said exposure method comprising:
detecting position information of said substrate with the detecting method according to claim 16; and
transferring said given pattern onto said substrate while controlling a position of said substrate based on the position information of said substrate detected in said detecting position information of said substrate.

18. The detecting method according to claim 14, wherein said object is at least one optical element, and the characteristic information of said object is optical characteristic information of said at least one optical element.

19. An exposure method with which to transfer a given pattern onto a substrate by illuminating with an exposure beam via an optical system, said exposure method comprising:
detecting optical characteristic information of said optical system with the detecting method according to claim 18; and
transferring said given pattern onto said substrate based on the detecting result of said detecting optical characteristic information.

20. An image processing method which comprises acquiring an image of a plurality of areas of which two adjacent areas have different image characteristics from each other; and analyzing said image with using the difference between image characteristics of said two adjacent areas to obtain information about a boundary between said two adjacent areas, wherein
said image is an image having no fewer than three tones that includes first and second areas which are different from each other in brightness of pixels in the vicinity of the boundary, and
said analyzing said image comprises:
calculating a threshold of brightness information to discriminate said first and second areas in said image based on a distribution of brightness of said image; and
obtaining a position on said pixel at which the brightness is estimated to be equal to said threshold, based on said brightness distribution of said image with accuracy higher than accuracy on the pixel scale, and estimating the obtained position to be a boundary position between said first and second areas.

21. The image processing method according to claim 20, wherein
said image is a set of brightness of a plurality of pixels arranged two-dimensionally along first and second directions, and
said estimating a boundary position comprises:
estimating a first estimated boundary position in said first direction based on brightness of first and second pixels that have a first magnitude relation and are adjacent to each other in said first direction in said image, and said threshold.

22. The image processing method according to claim 21, wherein said first magnitude relation is a relation where one of a first condition and a second condition is fulfilled, in said first condition brightness of said first pixel being greater than said threshold and brightness of said second pixel being not greater than said threshold, and in said second condition brightness of said first pixel being not less than said threshold and brightness of said second pixel being less than said threshold.

23. The image processing method according to claim 22, wherein said first estimated boundary position is at a position which divides internally a line segment joining the centers of said first and second pixels in proportion to an absolute value of difference between brightness of said first pixel and said threshold, and an absolute value of difference between brightness of said second pixel and said threshold.

24. The image processing method according to claim 21, wherein said estimating a boundary position further comprises:
estimating a second estimated boundary position in said second direction based on brightness of third and fourth pixels that have a second magnitude relation and are adjacent to each other in said second direction in said image, and said threshold.

25. The image processing method according to claim 24, wherein said second magnitude relation is a relation where one of a third condition and a fourth condition is fulfilled, in said third condition brightness of said third pixel being greater than said threshold and brightness of said fourth pixel being not greater than said threshold, and in a fourth condition brightness of said third pixel being not less than said threshold and brightness of said fourth pixel being less than said threshold.

26. The image processing method according to claim 25, wherein said second estimated boundary position is at a position which divides internally a line segment joining the centers of said third and fourth pixels in proportion to an absolute value of difference between brightness of said third pixel and said threshold, and an absolute value of difference between brightness of said fourth pixel and said threshold.

27. A detecting method with which to detect characteristic information of an object based on a distribution of light through said object when illuminating said object, said detecting method comprising:
processing an image formed by said light through said object with the image processing method according to claim 20; and
detecting characteristic information of said object based on the processing result of said processing an image.

28. The detecting method according to claim 27, wherein the characteristic information of said object is shape information of said object.

29. The detecting method according to claim 27, wherein the characteristic information of said object is position information of said object.

30. An exposure method with which to transfer a given pattern onto a substrate, said exposure method comprising:
detecting position information of said substrate with the detecting method according to claim 29; and
transferring said given pattern onto said substrate while controlling a position of said substrate based on the position information of said substrate detected in said detecting position information of said substrate.

31. The detecting method according to claim 27, wherein said object is at least one optical element, and the characteristic information of said object is optical characteristic information of said at least one optical element.

32. An exposure method with which to transfer a given pattern onto a substrate by illuminating with an exposure beam via an optical system, said exposure method comprising:
detecting optical characteristic information of said optical system with the detecting method according to claim 31; and
transferring said given pattern onto said substrate based on the detecting result of said detecting optical characteristic information.

33. An image processing method which comprises acquiring an image of a plurality of areas of which two adjacent areas have different image characteristics from each other; and analyzing said image with using the difference between image characteristics of said two adjacent areas to obtain information about a boundary between said two adjacent areas, wherein
said image has no fewer than three areas divided by no fewer than three boundary lines that extend radially from a specific point, and
said analyzing said image comprises:
preparing a template pattern that includes at least three line pattern elements extending from a reference point, and when said reference point coincides with said specific point, said at least three line pattern elements extend through respective areas of said no fewer than three areas and have level values corresponding to predicted level values of said respective areas; and
calculating a correlation value between said image and said template pattern in each position of said image, while moving said template pattern in said image.

34. The image processing method according to claim 33, wherein each said line pattern element extends along a bisector of an angle predicted to be made by the boundary lines of said respective areas in said image.

35. The image processing method according to claim 33, wherein the numbers of said no fewer than three boundary lines and said no fewer than three areas are four, and out of said four boundary lines, two boundary lines are substantially on a first straight line, and the other two boundary lines are substantially on a second straight line.

36. The image processing method according to claim 35, wherein said first and second straight lines are perpendicular to each other.

37. The image processing method according to claim 35, wherein the number of said line pattern elements is four.

38. The image processing method according to claim 37, wherein
among said four areas in said image, adjacent two areas are different from each other in level value, and
two areas diagonal across said specific point are substantially the same in level value.

39. The image processing method according to claim 33, wherein level values of said line pattern elements have a same magnitude relation as a magnitude relation of level values that said respective areas in said image is predicted to have.

40. A detecting method with which to detect position information of a mark that has no fewer than three areas divided by no fewer than three boundary lines extending radially from a specific point, said detecting method comprising:
acquiring an image formed by light through said object, and processing said image with the image processing method according to claim 33; and
detecting position information of said mark based on the processing result of said processing said image.

41. An exposure method with which to transfer a given pattern onto a substrate, said exposure method comprising:
detecting position information of a mark formed on at least one of said substrate and a measurement substrate with the detecting method according to claim 40; and
transferring said given pattern onto said substrate while controlling a position of said substrate based on the position information of said mark detected in said detecting position information of a mark.

42. An image processing unit which comprises an image acquiring unit which acquires an image of a plurality of areas of which two adjacent areas have different image characteristics from each other; and an image analyzing unit which analyzes said image with using the difference between image characteristics of said two adjacent areas to obtain information about a boundary between said two adjacent areas, wherein
said image includes first and second areas which have intrinsic image patterns different from each other and between which the boundary cannot be detected as a continuous line based on the differences between individual pixel data value, and
said image analyzing unit comprises:
a characteristic value calculating unit that calculates a texture characteristic's value in each position of a texture analysis window of a predetermined size based on pixel data in said texture analysis window, while moving said texture analysis window; and
a boundary estimating unit that estimates the boundary between said first and second areas based on a distribution of the texture characteristic's values calculated by said characteristic value calculating unit, and
when it is known that a specific area is a part of said first area in said image, said characteristic value calculating unit:
calculates said texture characteristic's value while changing a position of said texture analysis window in said specific area, and examines how said texture characteristic's value in said specific area varies according to the position of said texture analysis window; and
calculates said texture characteristic's value while changing a position of said texture analysis window outside said specific area.

43. The image processing unit according to claim 42, wherein
at least one of intrinsic patterns of said first and second areas is known, and
said characteristic value calculating unit calculates said texture characteristic's value while moving said texture analysis window whose size has been determined according to said known intrinsic pattern.

44. The image processing unit according to claim 42, wherein
it is known that a specific area is a part of said first area in said image, and
said characteristic value calculating unit obtains a size of said texture analysis window with which the texture characteristic's value is almost constant even when changing a position of said texture analysis window in said specific area, and calculates said texture characteristic's value while moving said texture analysis window of the obtained size.

45. The image processing unit according to claim 42, wherein said image acquiring unit is an image picking up unit.

46. A detecting unit which detects characteristic of an object based on a distribution of light through said object when illuminating said object, said detecting unit comprising:
an image processing unit according to claim 42, which processes an image formed by said light through said object; and
a characteristic detecting unit that detects characteristic information of said object based on the processing result of said image processing unit.

47. The detecting unit according to claim 46, wherein the characteristic information of said object is shape information of said object.

48. The detecting unit according to claim 46, wherein the characteristic information of said object is position information of said object.

49. An exposure apparatus which transfers a given pattern onto a substrate, said exposure apparatus comprising:
a detecting unit according to claim 48, which detects position information of said substrate; and
a stage unit that has a stage on which said substrate is mounted, the position information of said substrate being detected by said detecting unit.

50. The detecting unit according to claim 46, wherein said object is at least one optical element, and the characteristic information of said object is optical characteristic information of said at least one optical element.

51. An exposure apparatus which transfers a given pattern onto a substrate by illuminating with an exposure beam, said exposure apparatus comprising:
an optical system that guides said exposure beam to said substrate; and
a detecting unit according to claim 50, which detects characteristic information of said optical system.

52. An image processing unit which comprises an image acquiring unit which acquires an image of a plurality of areas of which two adjacent areas have different image characteristics from each other; and an image analyzing unit which analyzes said image with using the difference between image characteristics of said two adjacent areas to obtain information about a boundary between said two adjacent areas, wherein
said image has first and second areas which have intrinsic image patterns different from each other and between which the boundary cannot be detected as a continuous line based on the differences between individual pixel data value, and
said image analyzing unit comprises:
a weight determining unit that determines weight information which is assigned to each pixel in a square texture analysis window, and which is defined by a ratio of an inscribed circle area of said texture analysis window to a whole area of a rectangular sub-area, for each of said rectangular sub-areas into which said texture analysis window is divided according to each pixel:
a characteristic value calculating unit that calculates a texture characteristic's value in each position of said texture analysis window based on said weight information and each pixel data in said texture analysis window, while moving said texture analysis window; and
a boundary estimating unit that estimates a boundary between said first and second areas based on a distribution of the texture characteristic's values calculated by said characteristic value calculating unit.

53. The image processing unit according to claim 52, wherein said image acquiring unit is an image picking up unit.

54. A detecting unit which detects characteristic of an object based on a distribution of light through said object when illuminating said object, said detecting unit comprising:
an image processing unit according to claim 52, which processes an image formed by said light through said object; and
a characteristic detecting unit that detects characteristic information of said object based on the processing result of said image processing unit.

55. The detecting unit according to claim 54, wherein the characteristic information of said object is shape information of said object.

56. The detecting unit according to claim 54, wherein the characteristic information of said object is position information of said object.

57. An exposure apparatus which transfers a given pattern onto a substrate, said exposure apparatus comprising:
a detecting unit according to claim 56, which detects position information of said substrate; and
a stage unit that has a stage on which said substrate is mounted, the position information of said substrate being detected by said detecting unit.

58. The detecting unit according to claim 54, wherein said object is at least one optical element, and the characteristic information of said object is optical characteristic information of said at least one optical element.

59. An exposure apparatus which transfers a given pattern onto a substrate by illuminating with an exposure beam, said exposure apparatus comprising:
an optical system that guides said exposure beam to said substrate; and
a detecting unit according to claim 58, which detects characteristic information of said optical system.

60. An image processing unit which comprises an image acquiring unit which acquires an image of a plurality of areas of which has two adjacent areas have different image characteristics from each other; and an image analyzing unit which analyzes said image with using the difference between image characteristics of said two adjacent areas to obtain information about a boundary between said two adjacent areas, wherein
said image is an image having no fewer than three tones that includes first and second areas which are different from each other in brightness of pixels in the vicinity of the boundary, and
said image analyzing unit comprises:
a threshold calculating unit that calculates a threshold to discriminate said first and second areas in said image based on a distribution of brightness of said image; and
a boundary position estimating unit that obtains a position on said pixel at which the brightness is estimated to be equal to said threshold based on said brightness distribution of said image with accuracy higher than accuracy on the pixel scale, and estimates the obtained position to be a boundary position between said first and second areas.

61. The image processing unit according to claim 60, wherein said image acquiring unit is an image picking up unit.

62. A detecting unit which detects characteristic of an object based on a distribution of light through said object when illuminating said object, said detecting unit comprising:
an image processing unit according to claim 60, which processes an image formed by said light through said object; and
a characteristic detecting unit that detects characteristic information of said object based on the processing result of said image processing unit.

63. The detecting unit according to claim 62, wherein the characteristic information of said object is shape information of said object.

64. The detecting unit according to claim 62, wherein the characteristic information of said object is position information of said object.

65. An exposure apparatus which transfers a given pattern onto a substrate, said exposure apparatus comprising:
a detecting unit according to claim 64, which detects position information of said substrate; and
a stage unit that has a stage on which said substrate is mounted, the position information of said substrate being detected by said detecting unit.

66. The detecting unit according to claim 62, wherein said object is at least one optical element, and the characteristic information of said object is optical characteristic information of said at least one optical element.

67. An exposure apparatus which transfers a given pattern onto a substrate by illuminating with an exposure beam, said exposure apparatus comprising:
an optical system that guides said exposure beam to said substrate; and
a detecting unit according to claim 66, which detects characteristic information of said optical system.

68. An image processing unit which comprises an image acquiring unit which acquires an image of a plurality of areas of which two adjacent areas have different image characteristics from each other; and an image analyzing unit which analyzes said image with using the difference between image characteristics of said two adjacent areas to obtain information about a boundary between said two adjacent areas, wherein
said image has no fewer than three areas divided by no fewer than three boundary lines that extend radially from a specific point, and
said image analyzing unit comprises:
a template preparing unit that prepares a template pattern that includes at least three line pattern elements extending from a reference point, and when said reference point coincides with said specific point at least three line pattern elements extend through respective areas of said no fewer than three areas and have level values corresponding to predicted level values of said respective areas; and
a correlation value calculating unit that calculates a correlation value between said image and said template pattern in each position of said image, while moving said template pattern in said image.

69. The image processing unit according to claim 68, wherein said image acquiring unit is an image picking up unit.

70. A detecting unit which detects characteristic of an object based on a distribution of light through said object when illuminating said object, said detecting unit comprising:
an image processing unit according to claim 68, which processes an image formed by said light through said object; and
a characteristic detecting unit that detects characteristic information of said object based on the processing result of said image processing unit.

71. The detecting unit according to claim 70, wherein the characteristic information of said object is shape information of said object.

72. The detecting unit according to claim 70, wherein the characteristic information of said object is position information of said object.

73. An exposure apparatus which transfers a given pattern onto a substrate, said exposure apparatus comprising:
a detecting unit according to claim 72, which detects position information of said substrate; and
a stage unit that has a stage on which said substrate is mounted, the position information of said substrate being detected by said detecting unit.

74. The detecting unit according to claim 70, wherein said object is at least one optical element, and the characteristic information of said object is optical characteristic information of said at least one optical element.

75. An exposure apparatus which transfers a given pattern onto a substrate by illuminating with an exposure beam, said exposure apparatus comprising:
an optical system that guides said exposure beam to said substrate; and
a detecting unit according to claim 74, which detects characteristic information of said optical system.

76. A detecting unit which detects position information of a mark that has no fewer than three areas divided by no fewer than three boundary lines extending radially from a specific point, said detecting unit comprising:
an image processing unit according to claim 68 that acquires an image formed by light through said object and processes said image: and
a mark position detecting unit that detects position information of said mark based on the processing result of said image processing unit.

77. An exposure apparatus which transfers a given pattern onto a substrate, said exposure apparatus comprising:
a substrate supporting apparatus that supports at least one of said substrate and a measurement substrate; and
a detecting unit according to claim 76 which detects position information of a mark formed on at least one of said substrate and said measurement substrate supported by said substrate supporting apparatus.

78. An image processing method which comprises acquiring an image of a plurality of areas of which two adjacent areas have different image characteristics from each other; and analyzing said image with using the difference between image characteristics of said two adjacent areas to obtain information about a boundary between said two adjacent areas, wherein
said image includes first and second areas which have intrinsic image patterns different from each other and between which the boundary cannot be detected as a continuous line based on the differences between individual pixel data value, and
said analyzing said image comprises:
determining the size of a texture analysis window to perform texture analysis on said image with;
calculating a texture characteristic's value in each position of a texture analysis window of said determined size based on pixel data in said texture analysis window, while moving said texture analysis window; and
estimating a boundary between said first and second areas based on a distribution of the texture characteristic's values calculated in said calculating a texture characteristic's value, and
when it is known that a specific area is a part of said first area in said image, said determining comprises:
calculating said texture characteristic's value, while changing the position and size of said texture analysis window in said specific area; and
obtaining such a size of said texture analysis window that the texture characteristic's value is almost constant even when changing the position of said texture analysis window in said specific area.

79. The image processing method according to claim 78, wherein said texture characteristic's value is at least one of mean and variance of pixel data in said texture analysis window.

80. An image processing unit which comprises an image acquiring unit which acquires an image of a plurality of areas of which two adjacent areas have different image characteristics from each other; and an image analyzing unit which analyzes said image with using the difference between image characteristics of said two adjacent areas to obtain information about a boundary between said two adjacent areas, wherein
said image has first and second areas which have intrinsic image patterns different from each other and between which the boundary cannot be detected as a continuous line based on the differences between individual pixel data value, and
said image analyzing unit comprises:
a determining unit that determines. the size of a texture analysis window to perform texture analysis on said image with;
a characteristic value calculating unit that calculates a texture characteristic's value in each position of a texture analysis window of said determined size based on pixel data in said texture analysis window, while moving said texture analysis window; and
a boundary estimating unit that estimates the boundary between said first and second areas based on a distribution of the texture characteristic's values calculated by said characteristic value calculating unit, and
when it is known that a specific area is a part of said first area in said image, said determining unit obtains such a size of said texture analysis window that the texture characteristic's value is almost constant even when changing the position of said texture analysis window in said specific area.
